(19) United States
(12) Patent Application Publication
(10) Pub. No.: US 2024/0046107 A1
(43) Pub. Date: Feb. 8, 2024

(54) SYSTEMS AND METHODS FOR ARTIFICIAL-INTELLIGENCE MODEL TRAINING USING UNSUPERVISED DOMAIN ADAPTATION WITH MULTI-SOURCE META-DISTILLATION

(71) Applicant: HUAWEI TECHNOLOGIES CO., LTD., Shenzhen (CN)

(72) Inventors: Zhixiang CHI, Markham (CA); Li GU, Markham (CA); Tao ZHONG, Markham (CA); Yuanhao YU, Markham (CA); Yang WANG, Markham (CA); Jin TANG, Markham (CA)

(21) Appl. No.: 17/966,568

(22) Filed: Oct. 14, 2022

Related U.S. Application Data
(60) Provisional application No. 63/395,893, filed on Aug. 8, 2022.

(51) Int. Cl. G06N 3/08; G06N 3/04

(52) U.S. Cl. CPC G06N 3/088; G06N 3/0427

(57) ABSTRACT

A method has the steps of obtaining a set of training samples from one or more domains, using the set of training samples to query a plurality of artificial-intelligence (AI) models, combining the outputs of the queried AI models, and adapting a target AI model via knowledge distillation using the combined outputs.

### CROSS-REFERENCE TO RELATED APPLICATION

This application claims priority to and the benefit of U.S. Provisional Patent Application Ser. No. 63/395,893, filed Aug. 8, 2022, the content of which is incorporated herein by reference in its entirety.

### FIELD OF THE DISCLOSURE

The present disclosure relates generally to artificial intelligence (AI) systems, apparatuses, methods, and non-transitory computer-readable storage media, and in particular to AI systems, apparatuses, methods, and non-transitory computer-readable storage media for AI-model training using unsupervised domain adaptation with multi-source meta-distillation.

### BACKGROUND

Artificial intelligence (AI) has been used in many areas. Generally, AI involves the use of a digital computer or a machine controlled by a digital computer to simulate, extend, and expand human intelligence, perceive an environment, obtain knowledge, and use the knowledge to obtain a best result.

AI methods, machines, and systems analyze a variety of data for perception, inference, and decision making. Examples of areas for AI include robots, natural language processing, computer vision, decision making and inference, man-machine interaction, recommendation and searching, basic theories of AI, and the like.

AI machines and systems usually comprise one or more AI models which may be trained using a large amount of relevant data for improving the precision of their perception, inference, and decision making. In many cases, a trained AI model or a set of trained AI models may require a large amount of resources to implement or deploy. In such cases, knowledge distillation may be used to transfer the knowledge from the large AI model or models to a smaller model for ease of implementation. Thus, knowledge distillation may be considered a type of model compression.

### SUMMARY

According to one aspect of this disclosure, there is provided a method comprising: obtaining a set of training samples from one or more domains; using the set of training samples to query a plurality of artificial-intelligence (AI) models; combining the outputs of the queried AI models; and adapting a target AI model via knowledge distillation using the combined outputs.

In some embodiments, said combining the outputs of the queried AI models comprises: using a transformer encoder for combining the outputs of the queried AI models.

In some embodiments, said obtaining the set of training samples from the one or more domains comprises: obtaining the set of training samples from a plurality of domains, the set of training samples comprises a plurality of subsets of training samples obtained from the plurality of domains; said using the set of training samples to query the plurality of AI models comprises: using each subset of training samples to query the plurality of AI models except an excluded AI model of the plurality of AI models; and the excluded AI models of the plurality of subset of training samples are different AI models.

In some embodiments, said combining the outputs of the queried AI models comprises: weighting the outputs of the queried AI models, and combining the weighted outputs of the queried AI models to obtain a soft pseudo-label; and said adapting the target AI model via the knowledge distillation using the combined outputs comprises: adapting the target AI model via the knowledge distillation using the soft pseudo-label.

In some embodiments, said adapting the target AI model via the knowledge distillation using the combined outputs and the soft pseudo-label comprises: querying the target AI model using the set of training samples; and adapting the target AI model via the knowledge distillation based on Kullback-Leibler (KL) divergence of the output of the queried target AI model and the soft pseudo-label.

In some embodiments, said adapting the target AI model via the knowledge distillation based on the KL divergence of the output of the queried target AI model and the soft pseudo-label comprises: minimizing the KL divergence using a gradient decent method.

In some embodiments, the method further comprises: evaluating a loss of the target AI model; and updating a plurality of parameters based on the evaluated loss; the plurality of parameters comprises one or more first parameters of the target AI model and a parameter used in said combining the outputs of the queried AI models.

In some embodiments, said evaluating a loss of the target AI model comprises: querying the target AI model using a set of query samples, and evaluating a cross-entropy (CE) loss between the outputs of the queried target AI model and a set of labels corresponding to the set of query samples; and said updating the plurality of parameters based on the evaluated loss comprises: updating the plurality of parameters by minimizing the CE loss.

In some embodiments, said updating the plurality of parameters by minimizing the CE loss comprises: updating the plurality of parameters by minimizing the CE loss using a gradient decent method.

According to one aspect of this disclosure, there is provided an apparatus comprising: at least one processor for performing actions comprising: obtaining a set of training samples from one or more domains; using the set of training samples to query a plurality of AI models; combining the outputs of the queried AI models; and adapting a target AI model via knowledge distillation using the combined outputs.

According to one aspect of this disclosure, there is provided one or more non-transitory computer-readable storage devices comprising computer-executable instructions, wherein the instructions, when executed, cause a processing structure to perform actions comprising: obtaining a set of training samples from one or more domains; using the set of training samples to query a plurality of AI models; combining the outputs of the queried AI models; and adapting a target AI model via knowledge distillation using the combined outputs.

### BRIEF DESCRIPTION OF THE DRAWINGS

FIG. 1 is a simplified schematic diagram of an artificial intelligence (AI) system according to some embodiments of this disclosure;

FIG. 2 is a schematic diagram showing the hardware structure of the infrastructure layer of the AI system shown in FIG. 1, according to some embodiments of this disclosure;

FIG. 3 is a schematic diagram showing the hardware structure of a chip of the AI system shown in FIG. 1, according to some embodiments of this disclosure;

FIG. 4 is a schematic diagram of an AI model in the form of a deep neural network (DNN) used in the infrastructure layer shown in FIG. 2;

FIG. 5 is a schematic diagram showing AI-model deployment from a computer cloud of the AI system shown in FIG. 1 to an edge device thereof;

FIG. 6 is a schematic diagram showing the scenarios of deploying compact and large models from a computer cloud of the AI system shown in FIG. 1 to an edge device thereof;

FIG. 7 is a schematic diagram showing knowledge distillation from a teacher model to a student model;

FIG. 8 shows an example of training an AI model wherein a large-scale dataset is randomly split into a sample-training set and a sample-testing set with overlapping class categories and non-overlapping images;

FIG. 9 shows some examples that may cause domain shift;

FIG. 10 is a schematic diagram showing the impact of privacy-related regulations and/or considerations to AI-model training;

FIG. 11 is a schematic diagram showing prior-art unsupervised domain adaptation (UDA) methods for mitigating domain shift;

FIG. 12 is a schematic diagram showing prior-art source-free domain adaptation methods for mitigating domain shift;

FIG. 13 is a schematic diagram showing prior-art multi-source domain adaptation methods for mitigating domain shift;

FIG. 14 is a flowchart showing the steps of a Meta-Distillation of Mixture-of-Experts (Meta-DMoE) procedure or method executed by one or more training devices and edge devices of the AI system shown in FIG. 1 for training and deploying an AI model, according to some embodiments of this disclosure;

FIG. 15 is a flowchart showing the details of the knowledge distillation step of the Meta-DMoE procedure shown in FIG. 14, according to some embodiments of this disclosure;

FIGS. 16A to 16D show the features adapted to the same unseen target domains at test-time using ERM and the Meta-DMoE method 500, wherein

FIGS. 16A and 16B show the adapted features of ERM and Meta-DMoE on Camelyon17 datasets, respectively, and

FIGS. 16C and 16D show the adapted features of ERM and Meta-DMoE on iWildCam datasets, respectively;

FIG. 17 is a schematic diagram showing an example of using the Meta-DMoE method shown in FIG. 14 for training an AI model;

FIG. 18 is a flowchart showing the steps of a DMOT procedure executed by one or more training devices and/or one or more execution devices of the AI system shown in FIG. 1 for training and deploying an AI model to a target node, according to some embodiments of this disclosure;

FIG. 19 is a flowchart showing the steps of a DMOT procedure executed by one or more training devices and/or one or more execution devices of the AI system shown in FIG. 1 for training and deploying an AI model to a target node, according to some other embodiments of this disclosure; and

FIG. 20 is a flowchart showing the steps of a DMOT procedure executed by one or more training devices and/or one or more execution devices of the AI system shown in FIG. 1 for training and deploying an AI model to a target node, according to yet some other embodiments of this disclosure.

### DETAILED DESCRIPTION

### System Structure

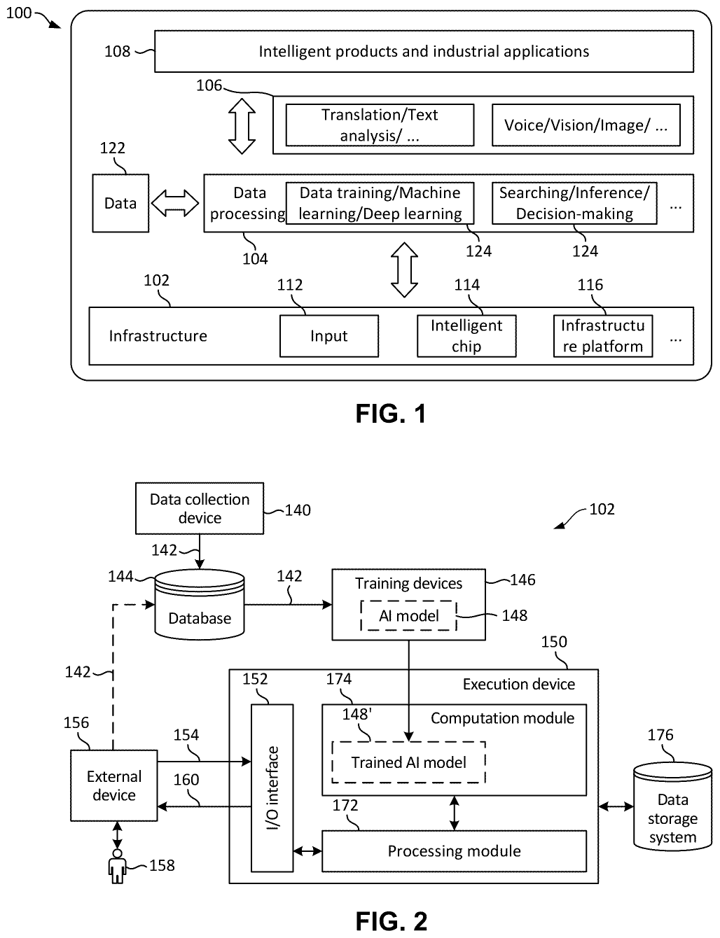

Turning now the FIG. 1, an artificial intelligence (AI) system according to some embodiments of this disclosure is shown and is generally identified using reference numeral 100. The AI system 100 comprises an infrastructure layer 102 for providing hardware basis of the AI system 100, a data processing layer 104 for processing relevant data and providing various functionalities 106 as needed and/or implemented, and an application layer 108 for providing intelligent products and industrial applications.

The infrastructure layer 102 comprises necessary input components 112 such as sensors and/or other input devices for collecting input data, computational components 114 such as one or more intelligent chips, circuitries, and/or integrated chips (ICs), and/or the like for conducting necessary computations, and a suitable infrastructure platform 116 for AI tasks.

The one or more computational components 114 may be one or more central processing units (CPUs), one or more neural processing units (NPUs; which are processing units having specialized circuits for AI-related computations and logics), one or more graphic processing units (GPUs), one or more application-specific integrated circuits (ASICs), one or more field-programmable gate arrays (FPGAs), and/or the like, and may comprise necessary circuits for hardware acceleration.

The platform 116 may be a distributed computation framework with networking support, and may comprise cloud storage and computation, an interconnection network, and the like.

In FIG. 1, the data collected by the input components 112 are conceptually represented by the data-source block 122 which may comprise any suitable data such as sensor data (for example, data collected by Internet-of-Things (IOT) devices), service data, perception data (for example, forces, offsets, liquid levels, temperatures, humidities, and/or the like), and/or the like, and may be in any suitable forms such as figures, images, voice clips, video clips, text, and/or the like.

The data processing layer 104 comprises one or more programs and/or program modules 124 in the form of software, firmware, and/or hardware circuits for processing the data of the data-source block 122 for various purposes such as data training, machine learning, deep learning, searching, inference, decision making, and/or the like.

In machine learning and deep learning, symbolic and formalized intelligent information modeling, extraction, preprocessing, training, and the like may be performed on the data-source block 122.

Inference refers to a process of simulating an intelligent inference manner of a human being in a computer or an intelligent system, to perform machine thinking and resolve a problem by using formalized information based on an inference control policy. Typical functions are searching and matching.

Decision making refers to a process of making a decision after inference is performed on intelligent information. Generally, functions such as classification, sorting, and inferencing (or prediction) are provided.

With the programs and/or program modules 124, the data processing layer 104 generally provides various functionalities 106 such as translation, text analysis, computer-vision processing, voice recognition, image recognition, and/or the like.

With the functionalities 106, the AI system 100 may provide various intelligent products and industrial applications 108 in various fields, which may be packages of overall AI solutions for productizing intelligent information decisions and implementing applications. Examples of the application fields of the intelligent products and industrial applications may be intelligent manufacturing, intelligent transportation, intelligent home, intelligent healthcare, intelligent security, automated driving, safe city, intelligent terminal, and the like.

FIG. 2 is a schematic diagram showing the hardware structure of the infrastructure layer 102, according to some embodiments of this disclosure. As shown, the infrastructure layer 102 comprises a data collection device 140 for collecting training data 142 for training an AI model 148 (such as a convolutional neural network) and storing the collected training data 142 into a training database 144. Herein, the training data 142 comprises a plurality of identified, annotated, or otherwise classified data samples that may be used for training (denoted “training samples” hereinafter) and corresponding desired results. Herein the training samples may be any suitable data samples to be used for training the AI model 148, such as one or more annotated images, one or more annotated text samples, one or more annotated audio clips, one or more annotated video clips, one or more annotated numerical data samples, and/or the like. The desired results are ideal results expected to be obtained by processing the training samples by using the trained or optimized AI model 148′. One or more training devices 146 (such as one or more server computers forming the so-called “computer cloud” or simply the “cloud”) train the AI model 148 using the training data 142 retrieved from the training database 144 to obtain the trained AI model 148′for use by the computation module 174 (described in more detail later).

As those skilled in the art will appreciate, in actual applications, the training data 142 maintained in the training database 144 may not necessarily be all collected by the data collection device 140, and may be received from other devices. Moreover, the training devices 146 may not necessarily perform training completely based on the training data 142 maintained in the training database 144 to obtain the trained AI model 148′, and may obtain training data 142 from a cloud or another place to perform model training.

The trained AI model 148′ obtained by the training devices 146 through training may be applied to various systems or devices such as an execution device 150 which may be a terminal such as a mobile phone terminal, a tablet computer, a notebook computer, an augmented reality (AR) device, a virtual reality (VR) device, a vehicle-mounted terminal, a server, or the like. The execution device 150 comprises an I/O interface 152 for receiving input data 154 from an external device 156 (such as input data provided by a user 158) and/or outputting results 160 to the external device 156. The external device 156 may also provide training data 142 to the training database 144. The execution device 150 may also use its I/O interface 152 for receiving input data 154 directly from the user 158.

The execution device 150 also comprises a processing module 172 for performing preprocessing based on the input data 154 received by the I/O interface 152. For example, in cases where the input data 154 comprises one or more images, the processing module 172 may perform image preprocessing such as image filtering, image enhancement, image smoothing, image restoration, and/or the like.

The processed data 142 is then sent to a computation module 174 which uses the trained AI model 148′ to analyze the data received from the processing module 172 for prediction. As described above, the prediction results 160 may be output to the external device 156 via the I/O interface 152. Moreover, data 154 received by the execution device 150 and the prediction results 160 generated by the execution device 150 may be stored in a data storage system 176.

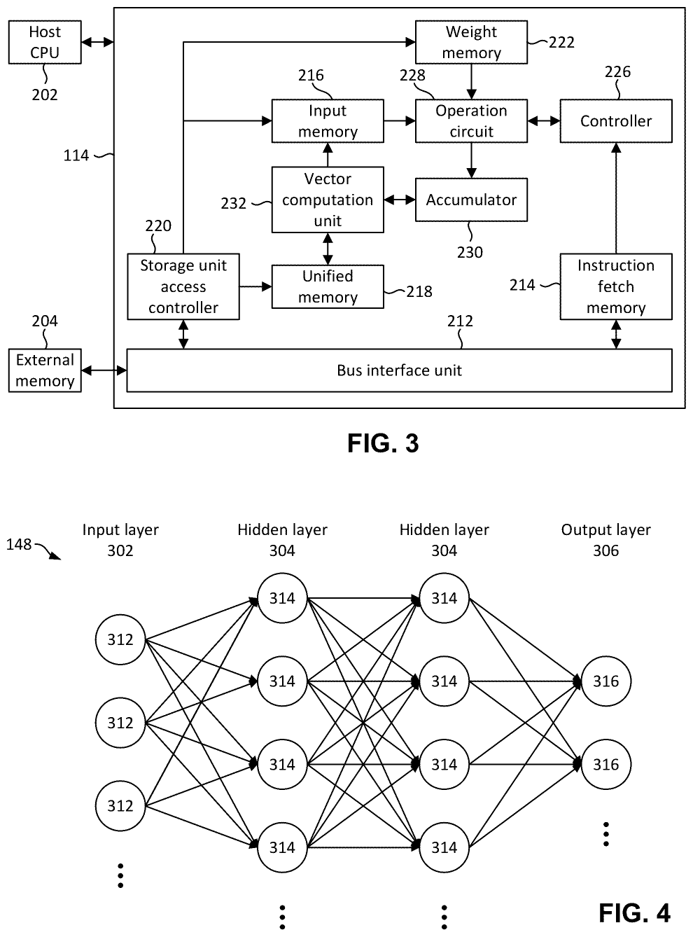

FIG. 3 is a schematic diagram showing the hardware structure of a computational component 114 according to some embodiments of this disclosure. The computational component 114 may be any processor suitable for large-scale exclusive OR operation processing, for example, a convolutional NPU, a tensor processing unit (TPU), a GPU, or the like. The computational component 114 may be a part of the execution device 150 coupled to a host CPU 202 for use as the computational module 160 under the control of the host CPU 202. Alternatively, the computational component 114 may be in the training devices 146 to complete training work thereof and output the trained AI model 148′.

As shown in FIG. 3, the computational component 114 is coupled to an external memory 204 via a bus interface unit (BIU) 212 for obtaining instructions and data (such as the input data 154 and weight data) therefrom. The instructions are transferred to an instruction fetch buffer 214. The input data 154 is transferred to an input memory 216 and a unified memory 218 via a storage-unit access controller (or a direct memory access controller, DMAC) 220, and the weight data is transferred to a weight memory 222 via the DMAC 220. In these embodiments, the instruction fetch buffer 214, the input memory 216, the unified memory 218, and the weight memory 222 are on-chip memories, and the input data 154 and the weight data may be organized in matrix forms (denoted “input matrix” and “weight matrix”, respectively).

A controller 226 obtains the instructions from the instruction fetch buffer 214 and accordingly controls an operation circuit 228 to perform multiplications and additions using the input matrix from the input memory 216 and the weight matrix from the weight memory 222.

In some implementations, the operation circuit 228 comprises a plurality of processing engines (PEs; not shown). In some implementations, the operation circuit 228 is a two-dimensional systolic array. The operation circuit 228 may alternatively be a one-dimensional systolic array or another electronic circuit that may perform mathematical operations such as multiplication and addition. In some implementations, the operation circuit 228 is a general-purpose matrix processor.

For example, the operation circuit 228 may obtain an input matrix A (for example, a matrix representing an input image) from the input memory 216 and a weight matrix B (for example, a convolution kernel) from the weight memory 222, buffer the weight matrix B on each PE of the operation circuit 228, and then perform a matrix operation on the input matrix A and the weight matrix B. The partial or final computation result obtained by the operation circuit 228 is stored into an accumulator 230.

If required, the output of the operation circuit 228 stored in the accumulator 230 may be further processed by a vector calculation unit 232 such as vector multiplication, vector addition, an exponential operation, a logarithmic operation, size comparison, and/or the like. The vector calculation unit 232 may comprise a plurality of operation processing engines, and is mainly used for calculation at a non-convolutional layer or a fully connected layer (FC) of the convolutional neural network, and may specifically perform calculation in pooling, normalization, and the like. For example, the vector calculation unit 232 may apply a non-linear function to the output of the operation circuit 228, for example a vector of an accumulated value, to generate an active value. In some implementations, the vector calculation unit 232 generates a normalized value, a combined value, or both a normalized value and a combined value.

In some implementations, the vector calculation unit 232 stores a processed vector into the unified memory 218. In some implementations, the vector processed by the vector calculation unit 232 may be stored into the input memory 216 and then used as an active input of the operation circuit 228, for example, for use at a subsequent layer in the convolutional neural network.

The data output from the operation circuit 228 and/or the vector calculation unit 232 may be transferred to the external memory 204.

FIG. 4 is a schematic diagram of the AI model 148 in the form of a deep neural network (DNN). The trained AI model 148′ generally has the same structure as the AI model 148 but may have a different set of parameters. As shown, the DNN 148 comprises an input layer 302, a plurality of cascaded hidden layers 304, and an output layer 306.

The input layer 302 comprises a plurality of input nodes 312 for receiving input data and outputting the received data to the computation nodes 314 of the subsequent hidden layer 304. Each hidden layer 304 comprises a plurality of computation nodes 314. Each computation node 304 weights and combines the outputs of the input or computation nodes of the previous layer (that is, the input nodes 312 of the input layer 302 or the computation nodes 314 of the previous hidden layer 304, and each arrow representing a data transfer with a weight). The output layer 306 also comprises one or more output node 316, each of which combines the outputs of the computation nodes 314 of the last hidden layer 304 for generating the outputs 356.

As those skilled in the art will appreciate, the AI model such as the DNN 148 shown in FIG. 4 generally requires training for optimization. For example, a training device 146 (see FIG. 2) may provide training data 142 (which comprises a plurality of training samples with corresponding desired results) to the input nodes 312 to run through the AI model 148 and generate outputs from the output nodes 316. By comparing the outputs obtained from the output nodes 316 with the desired results in the training data 142, a cost function may be established and the parameters of the AI model 148, such as the weights thereof, may be optimized by minimizing the cost function.

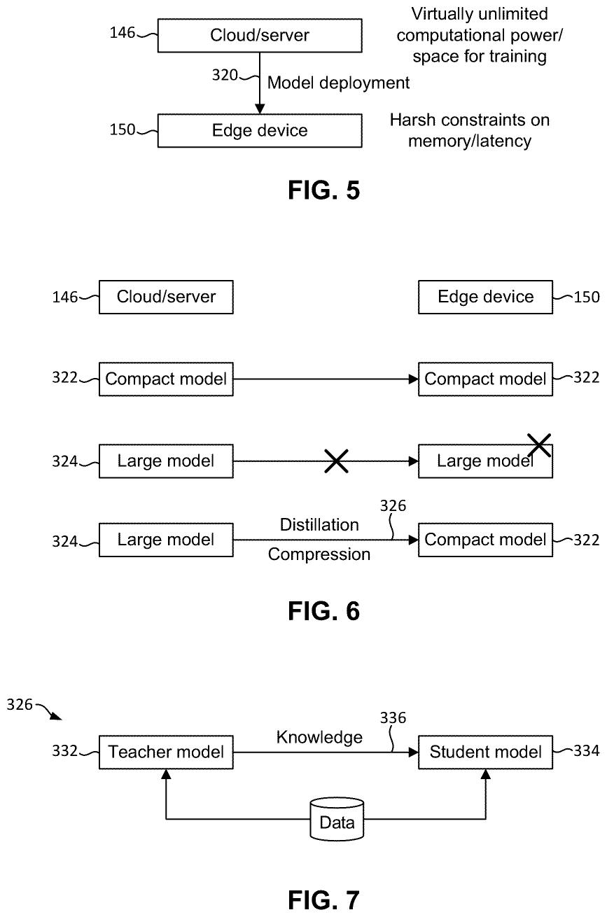

Training an AI model requires large number of iterations. Thus, the training process is usually conducted by one or more training devices 146 (such as computer servers or computer cloud). On the other hand, the trained model may be deployed in one or more execution devices 150 (also denoted “edge devices”). As shown in FIG. 5, compared to the edge devices 150, the cloud or servers 146 usually have virtually unlimited computational power and/or space for training the AI model. On the other hand, the edge devices 150 usually has harsh constraints on memory/latency. Consequently, there may exist some difficulties to deploy (320) the AI model to the edge devices 150.

As shown in FIG. 6, if the cloud or servers 146 obtain a compact AI model 322 after training, the compact AI model 322 may be deployed to the edge devices 150. However, if the cloud or servers 146 obtain a large AI model 324 after training, the large AI model 324 may not be able to be deployed to the edge devices 150. In this case, knowledge distillation or model compression 326 may be used to convert the large AI model 324 to a compact AI model 322 for deploying to the edge devices 150. As shown in FIG. 7, with knowledge distillation 326, a so-called teacher model 332 (which may be the large AI model 324) may transfer its knowledge 336 to a so-called student model 334 (which may be the compact AI model 322). By learning the knowledge from the teacher model 332, the student model may be deployed to edge device 150 and achieve similar or higher prediction accuracy compared to the large teacher model 332.

### AI-Model Training and Challenges Thereof

For ease of description and for generalization, in the following, an execution device 150 is also denoted a “user device”, a “device node”, or simply a “node”. Those skilled in the art may easily differentiate these terms from the “input node”, “computation node”, and “output node” used in above description of FIG. 4. A “source domain” refers to the dataset of a source node (also denoted a “training node”) that may be used for training an AI model to be deployed to a target node. A “target domain” refers to the dataset of a target node that may be used for testing the AI model deployed on the target node.

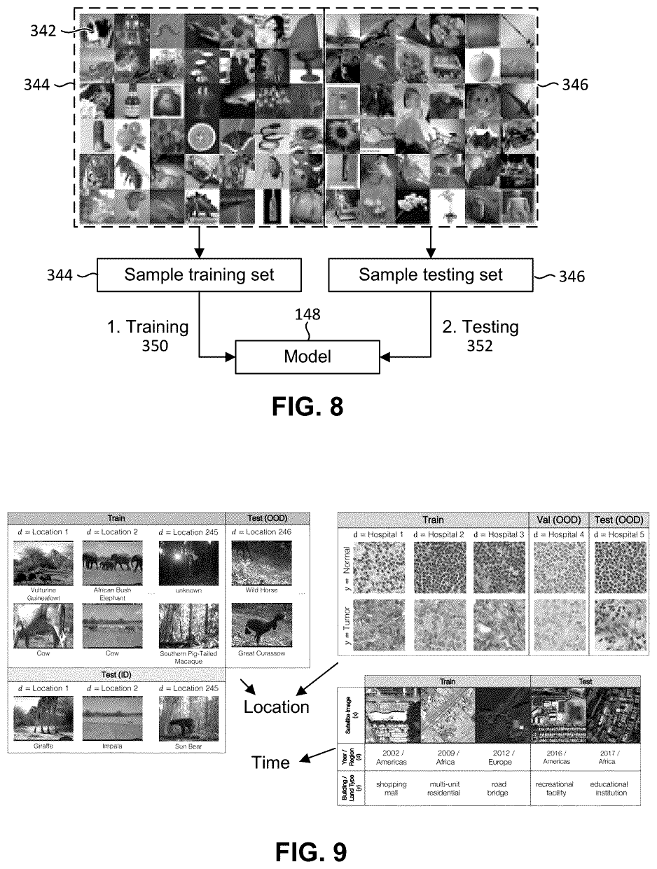

FIG. 8 shows an example of training an AI model wherein a large-scale dataset (such as a large-scale dataset of sample images) 342 is randomly split into a sample-training set 344 (also denoted a “training split”) and a sample-testing set 346 (also denoted a “testing split”) with overlapping class categories and non-overlapping images. An AI model 148 is then trained (350) on the training split 344 and tested (352) on the testing split 346 with fixed parameters. This process may be repeated to refine the AI model 350.

Such a process is based on the condition that the training and testing data are highly correlated (that is, they are both sampled from the same, independent and identically distributed (IID) sample-data distribution) and that the distributions of both training and testing sets 350 and 352 align. However, in many real-world scenarios, such conditions may not be always satisfied, and such an issue is known as domain shift (also denoted “distribution shift”; that is, the domain (the properties such as location, time, and/or the like related to the sample datasets) or the distribution of the sample datasets are “shifted” from the above-described ideal conditions). Domain shift may significantly hamper the performance of deep models.

FIG. 9 shows some examples that may cause domain shift, such as change in location and time for the taken images (wherein domain may be defined as location, time, and/or the like). Usually, domain shift may occur due to various reasons. For example, the training set may contain samples from various but limited number of domains. Consequently, during testing, the training set may not be sufficiently diverge to cover all cases (which may be dependent upon the changing deployment environments of the AI model 148). Moreover, misalignment between training and testing distributions may lead to performance drop.

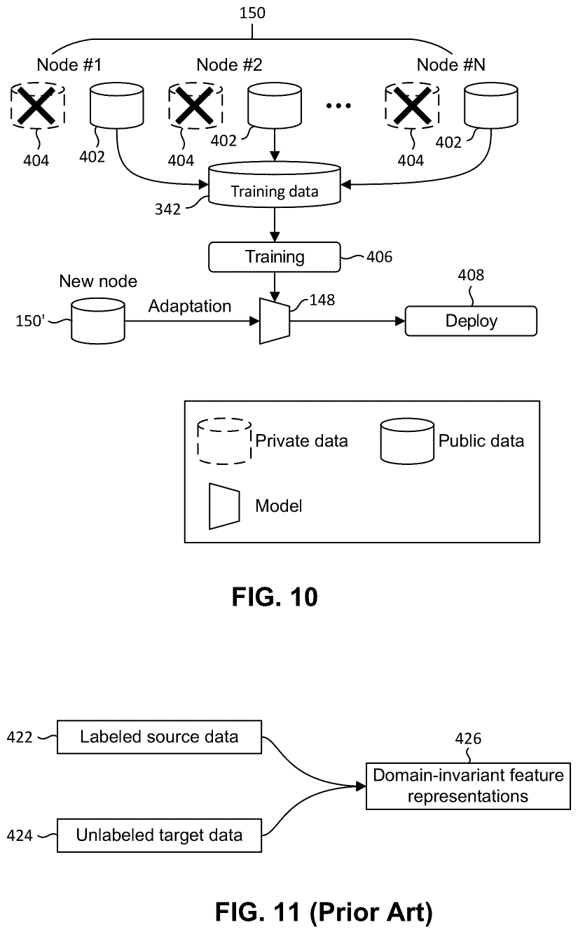

As those skilled in the art will appreciate, the large-scale labeled data is normally collected from public venues (such as from internet or among institutes) and stored in a server. Therefore, IID condition can be satisfied to train a more generic model by sampling mini-batches from the stored, public data. However, in many real-world scenarios, privacy-related regulations and/or considerations often affect data collection. For example, as shown in FIG. 10, the training device 146 (such as a global server) may obtain public data 402 from a plurality of nodes (node #1, node #2, . . . , node #N; which are user devices or execution devices 150) as the training data 342 for training (406, which may including the training and testing processes as shown in FIG. 8) an AI model 148, wherein batches are sampled under IID conditions. However, due to privacy-related regulations and/or considerations, the private data 404 of the nodes can only be processed locally by the respective nodes and cannot be shared with the training device 146. Thus, the private data 404 cannot be directly used for training a domain-adaptation model in most of existing approaches. As a result, the AI model 148 trained using the public data 402 may be biased. A node 150′ that is adapted to the AI model 148 may not produce accurate prediction results.

With above examples, it is clear that domain shift may significantly bias the trained AI models. Although human is more robust against the distribution shift, artificial learning-based systems may suffer more from performance degradation.

Various methods for mitigating the domain shift have been used in prior art. For example, FIG. 11 illustrates the unsupervised domain adaptation (UDA) methods based on the generative adversarial network (GAN), wherein the training requires the labeled source data 422 and unlabeled target data 424 (that is, the data of a target node that the AI model is to be deployed thereon). Source data 422 may be referred to a gathered large-scale public data. The target data comes 424 from a target node according to the testing/deployment scenario, and is an estimation of the target distribution.

UDA normally adapts to the target domain by transferring the source knowledge from the labeled source domain to the unlabeled target domain via a common feature space with less effect from domain discrepancy, which is achieved by developing domain-invariant via minimizing statistical discrepancy across domains. In other words, UDA maps the source and target data into a domain invariant feature space for domain-invariant feature representations 426 such that the model is robust to domain shift when it is deployed in target domain. Adversarial learning may also be applied to develop indistinguishable feature space.

However, UDA is less applicable for real-world scenarios as repetitive large-scale training is required for every target domain. The main limitation of UDA is the requirement of the co-existence of both the labeled source 422 and the unlabeled target data 424, which may be inapplicable when the target domain is unknown in advance. UDA assumes that there is only one target domain. Such an unrealistic assumption causes the issue that, when the AI model trained by UDA is to be deployed for a different domain (such as for a different user device 150), the AI model may needs to be trained again (which is inefficient). UDA also assumes a single-source condition (meaning that the source data comes from a single domain). However, in real-life, the source data is often collected from multiple domains.

Another limitation of UDA is that collecting the data samples from a target domain in advance may be inapplicable as the target may be unknown during training.

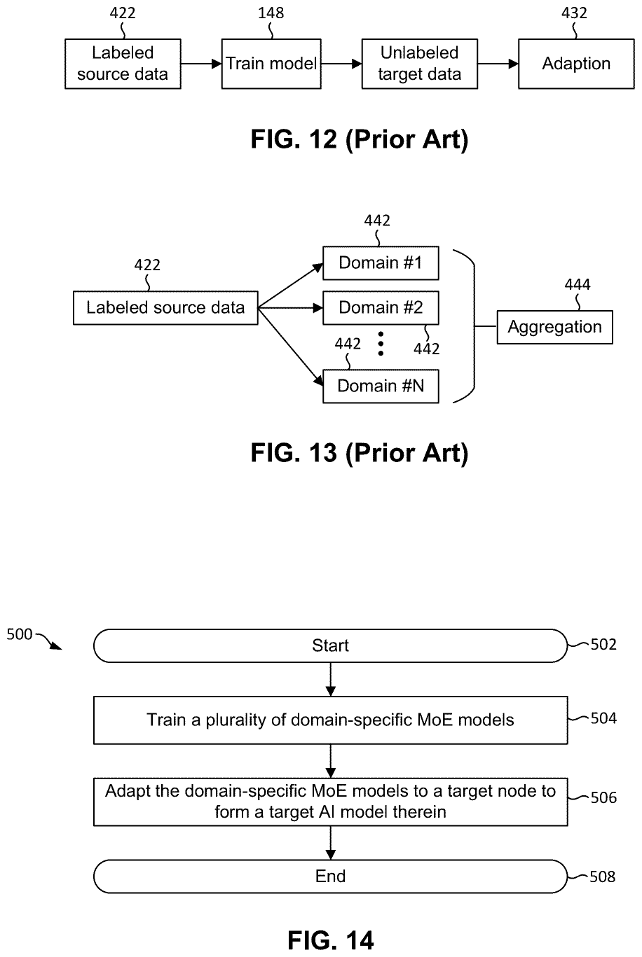

To drop the dependence on source domain data, algorithms toward source-free domain adaptation are closer to the real-world applications. FIG. 12 illustrates the source-free domain adaptation methods wherein the labeled source data 422 is used for training the AI model 148 and then is discarded at the adaptation stage 432. The source-free domain adaptation methods relax the condition of UDA and do not need to know the target domain in advance. Therefore, a single trained model is suitable for all target domains.

FIG. 13 shows the multi-source domain adaptation methods wherein the source data 422 is split into a plurality of distinct source-domains 442 as the data is collected from various execution devices 150 (wherein each execution device may be treated as a respective domain, which align with the real-world setting) for exploring the unique characteristics of each domain 442 and the dependencies therebetween for further strengthening the robustness.

The limitation of the source-free domain adaptation methods and the multi-source domain adaptation methods is that they do not take into account privacy considerations and compact-model settings.

Another group of methods for mitigating the domain shift are domain generalization which is based on the assumption that the prior knowledge of the target domains is unknown. Domain generalization methods leverage multiple source domains for training and directly use the trained model on all unseen domains. In other words, the domain generalization methods train a model on multiple domains and expect it to perform well on unseen target domains. Similar to DA methods, learning the domain-invariant feature representation is also effective. Data augmentation strategies in data or feature space are also promising. However, for most domain generalization methods, the same generic trained model is deployed to all unseen domains (in other words, the domain-specific information for the target domains is not adapted), which discards their domain speciality and yields sub-optimal solutions.

Adaptive risk minimization (ARM) is an adaptive method for mitigating the domain shift. ARM incorporates test-time adaptation (which is a special setting of unsupervised domain adaptation where a trained model on the source domain has to adapt to the target domain without accessing source data) with domain generalization. Meta-learning (which are machine-learning methods that learn another method (such as another machine learning method)) is utilized for training the model as an initialization such that it can be updated using the unlabeled data from each target domain before making predictions. However, it is observed that ARM only trains a single model, which is counterintuitive for the multi-source domain setting. There is a certain amount of correlation among the source domains while each of them also exhibits its own specific knowledge. When the number of source domains rises, data complexity dramatically increases, thereby impeding the exploration of the dataset thoroughly. Furthermore, real-world domains are not always balanced in data scales. Therefore, the single-model training is more biased toward the domain-invariant features and dominant domains instead of the domain-specific features.

Test-time adaptation (TTA) methods have also been used to address the domain shift. The TTA methods obtain a supervision signal at test-time to update the model before making a prediction. Rotation prediction may be used to update the model during inference. The input images may be reconstructed to achieve internal-learning to better restore the blurry images. TTA is also related to personalization as the adaptation process captures unique information.

Meta-learning methods are also known, which may be categorized as model-based, metric-based, and optimization-based methods. Meta-learning aims to train a model to achieve learning to learn. It is realized by episodic learning at the task level. Such bi-level optimization has been wildly applied in different tasks, such as coupling the performance of two tasks to achieve test-time adaptation and unsupervised adaptation for domain shift.

Mixture-of-Experts (MoE) methods decompose the whole training set into many subsets, which are independently learned by different models. MoE methods have been successfully applied in image recognition models to improve the accuracy, and are also popular in scaling up the architectures. As each expert is independently trained, sparse selection methods are developed to select a subset of the MoE during inference to increase the network capacity.

Compact models such as SqueezeNet and MobileNets have been developed in prior art. However, such compact models are not a choice for some domain adaptation methods. Experimental results show that replacing large AI models with the compact models may directly significantly degrade the performance because a model with large capacity is need to learn diverse knowledge.

### Meta-Distillation of Mixture-of-Experts Method

FIG. 14 is a flowchart showing the steps of a Meta-Distillation of Mixture-of-Experts (Meta-DMoE) procedure or method 500 executed by one or more training devices 146 and edge devices 150 for training and deploying an AI model, according to some embodiments of this disclosure. The Meta-DMoE procedure 500 provides a simple yet effective framework that is tailored for domain generalization tasks to harness its multi-domain characteristics.

After the procedure 500 starts (step 502), a plurality of nodes each trains a respective domain-specific model (step 504). In these embodiments, the plurality of domain-specific models may be a set of MoE models specialized in different domains. At this step, each MoE model is trained or learnt from the data of the corresponding domain.

At step 506, the training devices 146 use test-time adaptation as a knowledge transfer process to adapt the domain-specific MoE models to a target node by distilling the knowledge from the MoE models to the target node to form a trained AI model (also denoted a “target AI model”) therein. More specifically, the training devices 146 use unsupervised knowledge distillation to distill knowledge of the MoE models to a prediction network (that is, the trained AI model) in the target node.

The Meta-DMoE procedure 500 then ends (step 508).

Before describing the details of the Meta-DMoE procedure 500, some concepts and notations are first introduced.

Specifically, a set of N source domains [symbol] ={ [symbol] ⁱ}ᵢ₌₁^{N} and L target domains [symbol] ={ [symbol] }ⱼ₌₁^{L} are defined. The physical definition of a domain varies and depends on the applications or data collection methods. For example, a domain may be a specific dataset, a user device 150, a location, or the like. Let [symbol] ∈ [symbol] and [symbol] ∈ [symbol] and (where [symbol] represents the data space and [symbol] represents the label space) denote the input and corresponding label, respectively. Each of the source domains contains the data in the form of input-output pairs: [symbol] ={( [symbol] )}_{z=1}^{Z}^{ᵢ}. On the other hand, each of the target domains contains only the unlabeled data: [symbol] ={ [symbol] )}ₖ₌₁^{k}^{ⱼ}.

For well-designed datasets, all the source or target domains have the same number of data samples. Such condition is not ubiquitous for real-world scenarios (that is, Zᵢ_{₁}≠Zᵢ_{₂} if i₁≠i₂, and Kⱼ_{₁}≠Kⱼ_{₂} if j₁≠j₂) where data imbalance always exists. It further challenges the generalization with a broader range of real-world distribution shifts instead of finite synthetic ones. Generic domain shift tasks focus on the out-of-distribution (OOD) setting where the source and target domains are non-overlapping (that is, [symbol] ∩ [symbol] =ø), but the label spaces of both domains are the same (that is,) [symbol] = [symbol] ).

Conventional domain generalization methods perform training on [symbol] and make minimal assumption on the testing scenarios. Therefore, the same generic model is directly applied to all target domains [symbol] , which leads to non-optimal solutions. In fact, for each [symbol] , some unlabeled data are readily available which provide certain prior knowledge for that target distribution. ARM considers that a batch of unlabeled input data x approximates the input distribution pₓ which provides useful information about p_{y|x}. Based on such a consideration, an unsupervised test-time adaptation may be used is to adapt the model to the specific domain using x. Overall, ARM aims to minimize the following objective [symbol] (⋅;⋅) over all training domains (that is, over all training data):

$$\text{?} ℒ ( y , f ( x ; {θ}^{′} ) ) \text{?} \qquad ( 1 )$$

$$\text{?} \text{indicates text missing or illegible when filed}$$

where θ′=h(x, θ; ϕ), y is the labels corresponding to x, f (x; θ′) denotes the prediction function parameterized by θ. h(⋅; ϕ) is an adaptation function parameterized by ϕ. It receives the original parameter θ of the prediction network f and the unlabeled data x to adapt θ to θ′.

The goal of ARM is to learn both (θ, ϕ). To mimic the test-time adaptation (that is, adapt before prediction), it follows the episodic learning as in meta-learning. Specifically, each episode processes a domain by performing unsupervised adaptation using x and h(⋅; ϕ) in an inner loop to obtain the adapted prediction network f(⋅; θ′). An outer loop evaluates the adapted f(⋅; θ′) using the true label to perform meta-update. ARM is a general framework that may be incorporated with existing meta-learning approaches with different forms of adaptation module h(⋅;⋅).

However, several shortcomings are observed with respect to the generalization. The episodic learning processes one domain at a time, which has clear boundaries among the domains. The overall setting is equivalent to the multi-source domain setting, which is proven to be more effective than learning from a single domain as most of the domains are correlated to each other. However, it is counterintuitive to learn all the domain knowledge in one single model as each domain has specialized semantics or low-level features. Therefore, the single-model method in ARM is sub-optimal because:
(1) some domains may contain competitive information, which leads to negative knowledge transfer; it may tend to learn the ambiguous feature representations instead of capturing all domain-specific information;
(2) not all the domains are equally important, and the learning might be biased as the data in each domain is imbalanced in real-world.

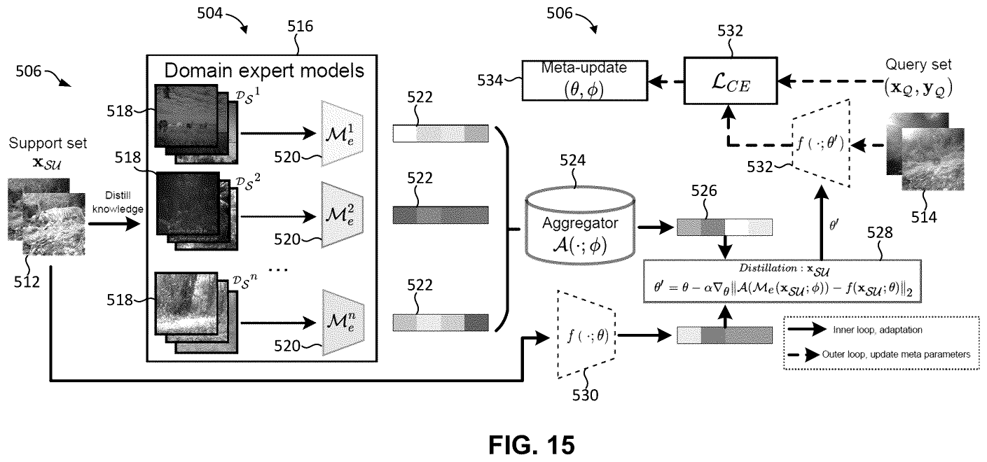

With above-described concepts and notations, FIG. 15 shows the details of the knowledge distillation step 506 of the Meta-DMoE procedure 500, according to some embodiments of this disclosure. In these embodiments, the knowledge distillation step 506 explicitly transfers valid knowledge from various domains to elevate the generalization of unseen domains.

For ease of description, the MoE is defined as [symbol] ={ [symbol] ⁱ}ᵢ₌₁^{N} to represent N domain-specific MoE models corresponding to N source domains { [symbol] }ᵢ₌₁^{N} . Each MoE model [symbol] is separately trained (at step 504) using supervised learning on the corresponding source domain [symbol] to learn its discriminative features.

In these embodiments, the data samples of each source domain [symbol] are split into unlabeled support set 512 (also denoted using symbol “ [symbol] ” hereinafter) and labeled query sets 514 (also denoted using symbol “( [symbol] )” hereinafter). The unlabeled support set [symbol] (or a sampled version thereof) is used to perform adaptation via knowledge distillation through an inner loop (represented by the solid-line arrows in FIG. 15), while the labeled query set ( [symbol] ) (or a sampled version thereof) is used to evaluate the adapted parameters to explicitly test the generalization on unseen data through an outer loop (represented by the dashed-line arrows in FIG. 15).

The Meta-DMoE procedure 500 uses the test-time adaptation at step 506 as the unsupervised knowledge distillation to learn the knowledge from the MoE [symbol] . In other words, the MoE [symbol] (or more specifically, the N domain-specific MoE models { [symbol] ⁱ}ᵢ₌₁^{N}) are used as the teacher models 332 to distill their knowledge to the prediction network f(⋅; θ) (that is, the student model 334; see FIG. 7) to achieve adaptation.

As shown in FIG. 15, a batch of unlabeled samples x are sampled from unlabeled support set [symbol] of a source domain, and are sent to the MoE [symbol] (also identified using reference numeral 516) to query their domain-specific knowledge 522 (denoted as { [symbol] ⁱ(x)}ᵢ₌₁^{N}). A plurality of feature extractor 520 extract the domain-specific knowledge 522 and forward it to a knowledge aggregator 524 (also denoted using symbol “ [symbol] (⋅; ϕ)”). The aggregator [symbol] (⋅; ϕ) explores the interconnection among domain knowledge 522 and yields knowledge composition towards that domain. The output 526 of the knowledge aggregator [symbol] (⋅; ϕ) is treated as a supervision signal to update (528) the prediction network f(x;θ) (also denoted using reference numeral 530). Once the adapted θ′ is obtained, the update prediction network f(⋅; θ′) (also denoted using reference numeral 532) is evaluated (532; for example, by minimizing a cross-entropy (CE) loss [symbol] _{CE}) using the labeled query set ( [symbol] ) to update (534) the meta-parameters (θ, ϕ).

Properly training the (θ, ϕ) is critical to improve the generalization on unseen domains. First, the knowledge aggregator [symbol] (⋅; ϕ) performs as a mechanism that explores and mixes the input knowledge, and should not be biased to any training data. Second, the conventional distillation process requires large numbers of data samples and learning iterations. The repetitive large-scale training is inapplicable in real-world applications.

To mitigate these challenges, the meta-learning method described in academic paper entitled “Model-agnostic meta-learning for fast adaptation of deep networks” to Finn, et al., published in International Conference on Lachine Learning, 2017, the content of which is incorporated herein by reference in its entirety, is used wherein a bi-level optimization enforces the knowledge aggregator [symbol] (⋅; ϕ) to learn beyond any specific knowledge and allows the student prediction network f(⋅; θ) to achieve fast adaptation.

The student prediction network f(⋅; θ) may be decoupled as a feature extractor θₑ and classifier θ_{c}. Unsupervised knowledge distillation may be achieved via the softened output or intermediate features from [symbol] . The former one allows the whole student network θ=(θₑ, θ_{c}) to be adaptive, while the latter one allows partial or complete θₑ to adapt to x, depending on the features utilized.

In some embodiments, θₑ is adapted in the inner loop while keeping the θ_{c} fixed. Thus, the adaptation process is achieved by distilling the knowledge via the aggregated features:

DIST(xsu, [symbol] ₑ, ϕ, θₑ)=θ′ₑ=θₑ−α∇_{θ}_{ₑ}∥ [symbol] ( [symbol] ₑ( [symbol] ); ϕ)−f( [symbol] l θₑ)∥₂, (2)

where α denotes the adaptation learning rate, [symbol] ₑ is the feature extractor 520 of MoE models which extracts the features before the classifier, and ∥⋅∥₂ measures the L2 distance. The goal is to obtain an updated θ′ₑ such that the extracted features of f( [symbol] l θ′ₑ) is close to the aggregated features. The overall learning objective of Meta-DMoE is to minimize the following expected loss:

$$arg \text{?} {ℒ}_{CE} ( {y}_{Q} , f ( {x}_{Q} ; \text{?} , \text{?} ) ) \text{?} \qquad ( 3 )$$

$$\text{?} \text{indicates text missing or illegible when filed}$$

where θ′ₑ=DIST( [symbol] , [symbol] ₑ, ϕ, θₑ), [symbol] _{CE} is the cross-entropy loss. Algorithm 1 below shows an exemplary implementation of the Meta-DMoE procedure 500. To smooth the meta gradient and stabilize the training, a batch of episodes are processed before each meta-update.

Algorithm 1 Training for Meta-DMoE

```
Require: { [symbol]  ⁱ}ᵢ₌₁^{N}: data of source domains; α, β: learning rates; B: meta batch size
  1: // Pretrain domain-specific MoE models
  2: for i=1,...,N do
  3: Train the domain-specific model [symbol]  ⁱ using [symbol]  ⁱ.
  4: end for
  5: // Meta-train aggregator [symbol]  (·; ϕ) and student model f (·, θₑ; θ_{c})
  6: Initialize: ϕ, θₑ, θ_{c}
  7: while not converged do
  8: Sample a batch of B source domains { [symbol]  ^{b}}^{B}, reset batch loss [symbol]  = 0
  9: for each [symbol]  ^{b} do
10: Sample support and query set: ( [symbol] ), ( [symbol] ) ~ [symbol]  ^{b}
11: [symbol]   ₑ^{l} ( [symbol] ; ϕ) = { [symbol]  ₑⁱ ( [symbol]  ; ϕ)}ᵢ₌₁^{N}, mask [symbol]  ₑⁱ ( [symbol]  ; ϕ) with 0 if b = i
12: Perform adaptation via knowledge distillation from MoE:
13: θₑ^{l} = θₑ − α∇_{θ}_{ₑ} ∥ [symbol]  ( [symbol]  ₑ^{l} ( [symbol]  ; ϕ)) − f( [symbol]  : θₑ)∥₂
14: Evaluate the adapted θₑ^{l} using query set and accumulate the loss:
15: [symbol]   = [symbol]  + [symbol] _{C E} ( [symbol]  , f( [symbol] ; θₑ^{l}, θ_{c}))
16: end for
17: Update ϕ, θₑ, θ_{c} for the current meta batch:
18: (ϕ, θₑ, θ_{c}) ← (ϕ, θₑ, θ_{c}) − β∇_{(ϕ, θe, θc)} [symbol]
19: end while
```

The Meta-DMoE procedure 500 in these embodiments is learned via meta-learning to mimic or simulate the test-time OOD scenarios and ensure positive knowledge transfer. Since the training domains overlap for the MoE and meta-training, the test-time OOD is simulated by excluding the corresponding expert model in each episode, which is implemented in Line 11 of Algorithm 1 by multiplying the features by 0 to mask them out. Therefore, the adaptation is enforced to use the knowledge that is aggregated from other domains.

Explicitly aggregating the knowledge from distinct domains requires exploring the relation among them to ensure the relevant knowledge transfer. Prior works design more specific hand-engineered techniques to combine the knowledge or choose data samples that are close to the target domain for knowledge transfer. An alternative is to replace the hand-designed pipelines with the fully learned solutions, including learning to learn algorithms using meta-learning. Following the same trend, the Meta-DMoE procedure 500 in these embodiments allows the aggregator [symbol] (⋅; ϕ) to be fully meta-learned without many manual designs except defining its architecture.

In some embodiments, the self-attention mechanism may be used where interaction among different domain knowledge can be computed. For example, a transformer encoder may be used as the aggregator [symbol] (⋅; ϕ) in some embodiments, such as the transformer described in academic paper entitled “An image is worth 16x16 words: Transformers for image recognition at scale” to Dosovitskiy, et al., published in International Conference on Learning Representations, 2021, and in academic paper entitled “Attention is all you need” to Vaswani, et al., published in Advances in Neural Information Processing Systems, 2017, the content of each of which is incorporated herein by reference in its entirety. The transformer encoder comprises multi-head self-attention and multi-layer perceptron blocks with layer normalization (LayerNorm; which is a technique to normalize the distributions of intermediate layers) applied before each block, and residual connection applied after each block. Then, the output features 522 from the MoE models { [symbol] ⁱ}ᵢ₌₁^{N} in the domain dimension is concatenated as Concat| [symbol] ₑ¹(x), [symbol] ₑ²(x), . . . [symbol] ₑ^{N}(x)|∈ [symbol] ^{N×d}, where d is the feature dimension. The aggregator [symbol] (⋅; ϕ) processes the concatenated features Concat| [symbol] ₑ¹(x), [symbol] ₑ²(x), . . . [symbol] ₑ^{N}(x)|∈ [symbol] ^{N×d} to obtain the aggregated feature F∈ [symbol] ^{d}, which is used as the supervision signal 526 for test-time adaptation.

In some embodiments, the Meta-DMoE method 500 does not comprise the masking step (Line 11 of Algorithm 1).

Testing results of the Meta-DMoE method 500 are now described.

Drastic variations in deployment conditions normally exist in nature. For example, in image recognition area, such variations may include a change in illumination, background, time, and/or the like. Such variations may lead to a huge domain gap between deployment environments and impose challenges to the robustness of the AI. Thus, in the testing, the Meta-DMoE method 500 is mainly evaluated on the real-world domain shift scenarios, and more specifically, on the large-scale distribution shift benchmark WILDS which reflects a diverse range of real-world distribution shifts. The testing is mainly performed on five image testbeds, including iWildCam, Camelyon17, RxRx1, FMoW, and PovertyMap. In each benchmark dataset, a domain represents a distribution over data that is similar in some way, such as images collected from the same camera trap or satellite images taken in the same locations. A plurality of evaluation metrics including accuracy, Macro F1, worst-case (WC) accuracy, Pearson correlation (r), and its worst-case counterpart, are computed.

Following WILDS, the testing uses ResNet18 & 50 or DenseNet101 for the expert models { [symbol] ⁱ}ᵢ₌₁^{N} and student network f(⋅; θ′). Also, a single-layer transformer encoder block of above-described academic paper entitled “Attention is all you need” is used as the knowledge aggregator [symbol] (⋅;θ). To investigate the resource-constrained and privacy-sensitive scenarios, MobileNet V2 is used with a width multiplier of 0.25.

WILDS benchmark is highly imbalanced in data size, and some classes have empty input data set. Consequently, it is observed that using every single domain to train an expert is unstable, and sometimes it cannot converge. Thus, in the testing, the training domains are clustered into N super domains with each super-domain being used to train the expert models. Specifically, N={10, 5, 3, 4, 3} are used for iWildCam, Camelyon17, RxRx1, FMoW, and Poverty Map, respectively. ImageNet pre-trained model is used as the initialization and separately train the models using Adam optimizer with a learning rate of 1e⁻⁴ and a decay of 0.96 per epoch.

In the testing, the aggregator and student network are pre-trained using supervised learning to improve the convergence speed. After that, the model is further trained using above-described Algorithm 1 for 15 epochs with a fixed learning rate of 3e⁻⁴ for α and e⁻⁵ for β. During meta-testing, Line 13 of Algorithm 1 is used to adapt before making a prediction for every testing domain. For both meta-training and testing, one gradient update is performed for adaptation on the unseen target domain.

For all experiments in the testing, the hyper-parameters are tuned using the validation split and a final evaluation on the test split is conducted.

Table 1 shows the metric means (higher numbers are better) and the standard deviations (indicated in parentheses) of image recognition and regression accuracy of the Meta-DMoE method 500 with some prior-art methods including the empirical risk minimization (ERM) method, the correlation alignment (CORAL) method, the group distributionally robust optimization (Group DRO) method, the invariant risk minimization (IRM) method, and the adaptive methods used in ARM (adaptive risk minimization-contextual meta-learner (ARM-CML), adaptive risk minimization-batchnorm (ARM-BN), and adaptive risk minimization-learned loss (ARM-LL)).

The testing of these methods are conducted using OOD setting and on WILDS image testbeds. The above-described Algorithm 1 is used as the Meta-DMoE method 500 (shown as “Meta-DMoE” in Table 1) for comparison. Moreover, the Meta-DMoE method 500 without masking the in-distribution domain in MoE models during meta training (Line 11 of Algorithm 1) is also evaluated (shown as “Meta-DMoE w/o masking” in Table 1), where the sampled domain is overlapped with MoE.

TABLE 1
Comparison of Meta-DMoE with prior-art methods using OOD setting and on WILDS
image testbeds

| | iWildCam | | Camelyon17 | RxRx1 | FMoW | | Poverty Map | |
|---|---|---|---|---|---|---|---|---|
| Method | Acc | Macro F1 | Acc | Acc | WC Acc | Avg Acc | WC Pearson r | Pearson r |
| ERM | 71.6 (2.5) | 31.0 (1.3) | 70.3 (6.4) | 29.9 (0.4) | 32.3 (1.25) | 53.0 (0.55) | 0.45 (0.06) | 0.78 (0.04) |
| CORAL | 73.3 (4.3) | 32.8 (0.1) | 59.5 (7.7) | 28.4 (0.3) | 31.7 (1.24) | 50.5 (0.36) | 0.44 (0.06) | 0.78 (0.05) |
| Group DRO | 72.7 (2.1) | 23.9 (2.0) | 68.4 (7.3) | 23.0 (0.3) | 30.8 (0.81) | 52.1 (0.5) | 0.39 (0.06) | 0.75 (0.07) |
| IRM | 59.8 (3.7) | 15.1 (4.9) | 64.2 (8.1) | 8.2 (1.1) | 30.0 (1.37) | 50.8 (0.13) | 0.43 (0.07) | 0.77 (0.05) |
| ARM-CML | 70.5 (0.6) | 28.6 (0.1) | 84.2 (1.4) | 17.3 (1.8) | 27.2 (0.38) | 45.7 (0.28) | 0.37 (0.08) | 0.75 (0.04) |
| ARM-BN | 70.3 (2.4) | 23.7 (2.7) | 87.2 (0.9) | 31.2 (0.1) | 24.6 (0.04) | 42.0 (0.21) | 0.49 (0.21) | 0.84 (0.05) |
| ARM-LL | 71.4 (0.6) | 27.4 (0.8) | 84.2 (2.6) | 24.3 (0.3) | 22.1 (0.46) | 42.7 (0.71) | 0.41 (0.04) | 0.76 (0.04) |
| Meta-DMoE | 74.1 (0.4) | 35.1 (0.9) | 90.8 (1.3) | 29.6 (0.5) | 36.8 (1.01) | 50.6 (0.20) | 0.52 (0.04) | 0.80 (0.03) |
| (w/o mask) | | | | | | | | |
| Meta-DMoE | 77.2 (0.3) | 34.0 (0.6) | 91.4 (1.5) | 29.8 (0.4) | 35.4 (0.58) | 52.5 (0.18) | 0.51 (0.04) | 0.80 (0.03) |

Clearly, the Meta-DMoE method 500 performs well across all datasets and increases both worst-case and average accuracy compared to other methods. The Meta-DME method 500 achieves the best performance on four (4) out of five (5) benchmark datasets.

The ARM methods apply the meta-learning approach to learn how to adapt to unseen domains with unlabeled data. However, they are greatly bounded by using a single model to exploit knowledge from multiple source domains. Instead, the Meta-DMoE method 500 is more fitted to multi-source domain settings and meta-trains an aggregator that properly mixtures the knowledge from multiple domain-specific experts. As a result, the Meta-DMoE method 500 outperforms ARM-CML, ARM-BN and ARM-LL by 9.5%, 9.8%, 8.1% for iWildCam, 8.5%, 4.8%, 8.5% for Camelyon17 and 14.8%, 25.0%, 22.9% for FMoW in terms of average accuracy.

Those skilled in the art will appreciate that the Meta-DMoE w/o masking shown in Table 1 violates the generalization to unseen target domains during testing. As shown in Table 1, most of the performance of Meta-DMoE w/o masking drops, which reflects the importance of aligning the training and evaluation objectives.

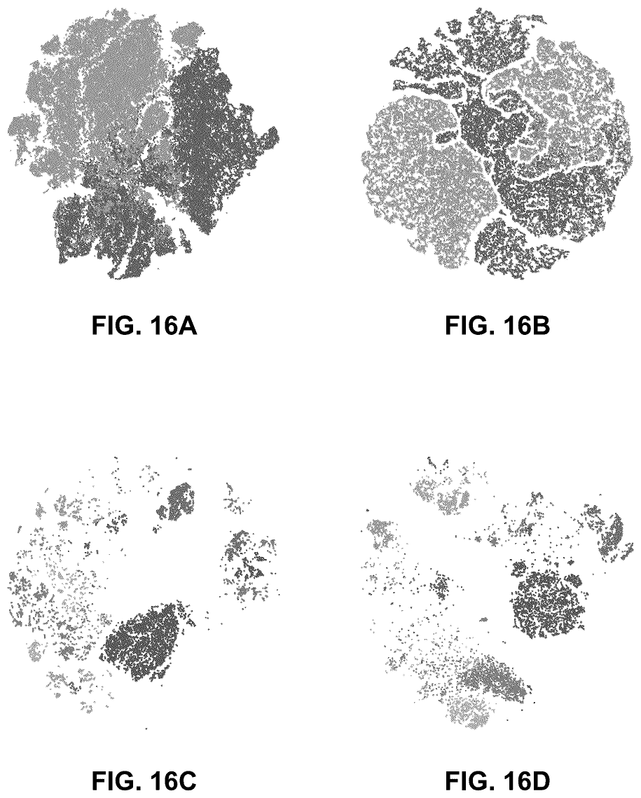

To evaluate the capability of adaptation via learning discriminative representations on unseen target domains, t-Distributed Stochastic Neighbor Embedding (t-SNE) is used for feature visualization using the same test domain sampled from iWildCam and Camelyon17 datasets. ERM utilizes single model and standard supervised training without adaptation, and thus is used as the baseline. FIGS. 16A to 16D show the features adapted to the same unseen target domains at test-time using ERM and the Meta-DMoE method 500, wherein FIGS. 16A and 16B show the adapted features of ERM and Meta-DMoE on Camelyon17 datasets, respectively, and FIGS. 16C and 16D show the adapted features of ERM and Meta-DMoE on iWildCam datasets, respectively. In FIGS. 16A to 16D, each point represents a data sample and different colors represent different classes. It is clear that the Meta-DMoE method 500 obtains better clustered and more discriminative decision boundaries.

In real-world deployment environments such as edge devices (for example, smartphones), the computational power may be highly constrained, and thus require fast inference and compact models. However, the reduction in learning capabilities greatly hinders the generalization as some methods utilize only a single model regardless of the data complexity. On the other hand, when the number of domain data scales up, methods relying on adaptation on every data sample may experience inefficiency.

In contrast, the Meta-DMoE method only needs to perform adaptation once for every unseen domain. Only the final prediction network f(⋅; θ′) is used for inference. To investigate the impact on generalization caused by reducing the model size, MobileNet V2 (a convolutional neural network having 53 layers) is used as a model-size reduced version of the AI model f(⋅; θ) in the testing.

Table 2 shows the comparison the Meta-DMoE method 500 with some prior-art methods including ERM, CORAL, ARM-CML, ARM-BN, and ARM-LL on the WILDS testbeds and using MobileNet V2.

TABLE 2
Comparison of Meta-DMoE with prior-art methods using a size-reduced AI model

| | iWildCam | | Camelyon17 | RxRx1 | FMoW | | Poverty Map | |
|---|---|---|---|---|---|---|---|---|
| Method | Acc | Macro F1 | Acc | Acc | WC Acc | Avg Acc | WC Pearson r | Pearson r |
| ERM | 56.7 (0.7) | 17.5 (1.2) | 69.0 (8.8) | 14.3 (0.2) | 15.7 (0.68) | 40.0 (0.11) | 0.39 (0.05) | 0.77 (0.04) |
| CORAL | 61.5 (1.7) | 17.6 (0.1) | 75.9 (6.9) | 12.6 (0.1) | 22.7 (0.76) | 31.0 (0.32) | 0.44 (0.06) | 0.79 (0.04) |
| ARM-CML | 58.2 (0.8) | 15.8 (0.6) | 74.9 (4.6) | 14.0 (1.4) | 21.1 (0.33) | 30.0 (0.13) | 0.41 (0.05) | 0.76 (0.03) |
| ARM-BN | 54.8 (0.6) | 13.8 (0.2) | 85.6 (1.6) | 14.9 (0.1) | 17.9 (1.82) | 29.0 (0.69) | 0.42 (0.05) | 0.76 (0.03) |
| ARM-LL | 57.5 (0.5) | 12.6 (0.8) | 84.8 (1.7) | 15.0 (0.2) | 17.1 (0.22) | 30.3 (0.54) | 0.39 (0.07) | 0.76 (0.02) |
| Meta-DMoE | 59.5 (0.7) | 19.7 (0.5) | 87.1 (2.3) | 15.1 (0.4) | 26.9 (0.67) | 37.9 (0.31) | 0.44 (0.04) | 0.77 (0.03) |

As can be seen, the Meta-DMoE method 500 still outperforms the prior-art methods. Since the MoE model is only used for knowledge transfer, the Meta-DMoE method 500 is more flexible than the prior-art methods in designing the student architecture for different scenarios. Multiply-accumulate operations (MACS) for inference and time complexity on adaptation are also tested and the test results are shown in Table 3. As ARM needs to make adaptation before inference on every example, its adaptation cost scales linearly with the number of examples. On the other hand, the Meta-DMoE method 500 performs better than ERM, ARM-CML, and ARM-LL in accuracy and requires much less computational cost (constant time complexity) in test-time adaptation.

TABLE 3
Adaptation efficiency evaluated on
iWildCam using MobileNet V2

| Method | Acc/Macro-F1 | MACS | Complexity |
|---|---|---|---|
| ERM | 56,7/17.5 | 7.18 × 10⁷ | N/A |
| ARM-CML | 58.2/15.8 | 7.73 × 10⁷ | O(n) |
| ARM-LL | 57.5/12.6 | 7.18 × 10⁷ | O(n) |
| Meta DMoE | 59.5/19.7 | 7.18 × 10⁷ | O(1) |

Large-scale training data is normally collected from various venues. However, some venues may have privacy regulations enforced. Their data may not be accessible but the models that are trained using the private data are available.

The Meta-DMoE method 500 does not need to access the raw private data. Rather, it only needs to access the trained models, thereby greatly mitigating the impact of privacy regulations and/or considerations.

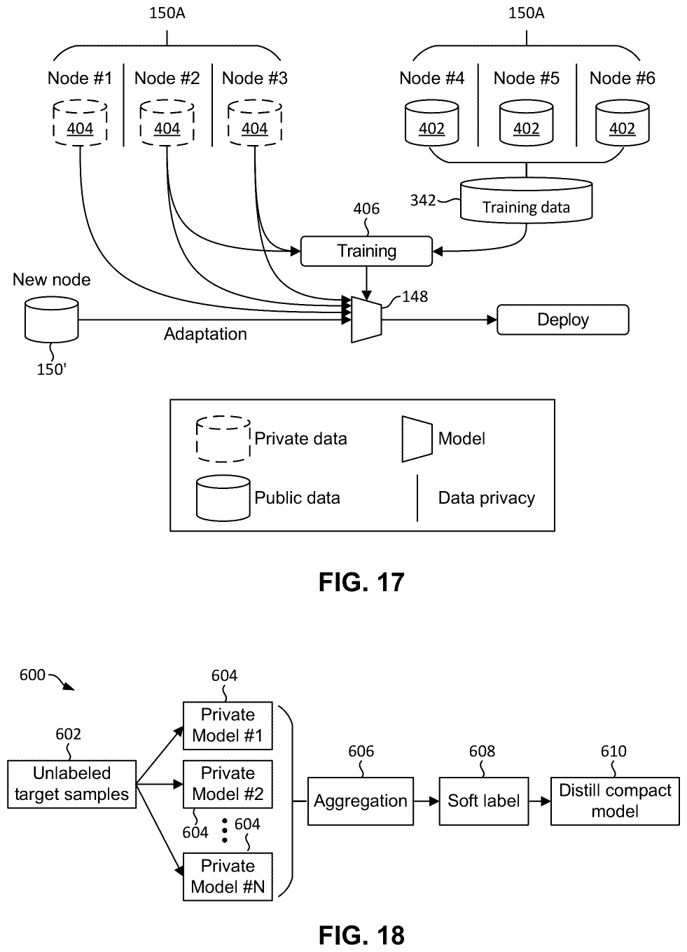

FIG. 17 shows an example, wherein some nodes 150A contains public data 402 which is collected by the training device 146 (such as a global server) as the training data 342 for training (406) one or more domain-specific AI models (corresponding to step 504 of the Meta-DMoE method 500; see FIG. 14). Some other nodes 150B contains private data 404 which may be processed locally and separately for training their respective domain-specific AI models (also corresponding to step 504 of the Meta-DMoE method 500; see FIG. 14). Then, all trained domain-specific AI models are combined (corresponding to step 506 of the Meta-DMoE method 500) using unsupervised knowledge distillation to distill knowledge of the domain-specific models to a prediction network 148. Thus, in training the AI model 148, nodes 150A contribute their training data and nodes 150B contribute their trained AI models (instead of their private training data).

The impact of private data is also tested. To simulate an environment as shown in FIG. 17, the training source domains are partitioned into two splits: private domains ( [symbol] ^{pri}) and public domains ( [symbol] ^{pub}). The private domains [symbol] ^{pri} are used to train MoE models and the public domains [symbol] ^{pub} are used for the subsequent meta-training. Since ARM and other methods only utilize the data as input, they are trained on [symbol] ^{pub}. The testing is conducted to evaluate the impact of privacy regulations. Table 4 shows the testing results.

TABLE 4
Testing results on privacy-related regulation setting
on iWildCam and FMoW using MobileNet V2

| | iWildCam | | FMoW | |
|---|---|---|---|---|
| Method | Acc | Macro-F1 | WC Acc | Acc |
| ERM | 51.2 | 11.2 | 22.5 | 35.4 |
| CORAL | 50.2 | 11.1 | 18.1 | 25.4 |
| ARM-CML | 42.7 | 7.5 | 16.8 | 24.1 |
| ARM-BN | 46.9 | 8.7 | 14.2 | 22.2 |
| ARM-LL | 46.8 | 9.3 | 13.7 | 22.6 |
| Meta-DMoE | 54.7 | 14.2 | 24.4 | 33.8 |

As shown in Table 4, the Meta-DMoE method 500 does not suffer from much performance degradation. On the other hand, prior-art methods such as ERM, CORAL, ARM-CML, ARM-BN, and ARM-LL that can only exploit public data exhibits far worse performance.

Ablation studies are also conducted to investigate the performance of the AI system 100 by removing some components thereof. The ablation studies are conducted on iWildCam to analyze various components of the Meta-DMoE method 500 to answer two key questions: (1) does the number of experts affect the capability of capturing knowledge from multi-source domains? (2) does meta-learning perform better than standard supervised learning under the knowledge distillation frame-work?

With respect to the number of domain-specific experts (that is, question 1), those skilled in the art will appreciate that, instead of using a single network, the Meta-DMoE method 500 exploits multiple experts to store domain-specific knowledge separately. Increasing the number of experts improves the capability of fully exploring the speciality of each domain. Therefore, the adaptation to unseen target domain is also enhanced. Table 5 shows the test results on the number of domain-specific experts, which validates the benefits of using more domain-specific experts, that is, more experts increase the learning capacity to better explore each source domain, thus, improving generalization.

TABLE 5
Results on the number of domain-specific experts

| # of experts | 2 | 5 | 7 | 10 |
|---|---|---|---|---|
| Accuracy | 70.4 | 74.1 | 76.4 | 77.2 |
| Macro-F1 | 30.6 | 32.3 | 33.7 | 34.0 |

With respect to the training method (that is, question 2), three training methods, random initialization, pre-train, and meta-train, are investigated to verify the effectiveness of meta-learning. To pre-train the aggregator [symbol] (⋅; ϕ), a classifier layer is added to its aggregated output following the standard supervised training method. The same testing method including the number of updates and images for adaptation is used for fair comparisons.

Table 6 reports the results of different training method combinations. It can be observed from Table 6 that the randomly initialized student model struggles to learn with only a few-shot data, and the pre-trained aggregator brings weaker adaptation guidance to the student network as the aggregator is not learned to distill. In contrast, the bi-level optimization-based training method used in the Meta-DMoE method 500 enforces the aggregator to choose more correlated knowledge from multiple experts to improve the adaptation of the student model. Therefore, the meta-learned aggregator is more optimal (row 1 vs. row 2). Furthermore, the Meta-DMoE method 500 simulates the adaptation in testing scenarios, which aligns with the training objective and evaluation protocol. Hence, using both meta-trained aggregator and student models improves generalization (row 3 vs. row 4) as they are learned towards test-time adaptation.

TABLE 6
Evaluation of training methods.

| Train Scheme | | Metrics | |
|---|---|---|---|
| Aggregator | Student | Acc | Macro-F1 |
| Pretrain | Random | 6.2 | 0.1 |
| Meta | Random | 32.7 | 0.5 |
| Pretrain | Meta | 74.8 | 32.9 |
| Meta | Meta | 77.2 | 34.0 |

With respect to aggregator and distillation methods, Table 7 shows the importance of various architecture choices of the knowledge aggregator. The fully learned aggregator is important or even crucial for mixing domain-specific features and outperforms other hand-designed aggregation operators such as max and average pooling. Table 7 shows that the transformer encoder explores interconnection and gives the best result.

TABLE 7
Comparison of different aggregator methods

| | Max | Average | Transfornier encoder |
|---|---|---|---|
| Accuracy | 69.2 | 69.7 | 77.2 |
| Marco-F1 | 29.2 | 25.0 | 34.0 |

Another important aspect in the Meta-DMoE method 500 is the form of knowledge such as distilling the teacher model's logits, intermediate features (denoted “Feat.”), or both. Table 8 shows the evaluation results of these three forms of knowledge, wherein distilling only the feature extractor (used in the Meta-DMoE method 500) yields the best generalization.

TABLE 8
Comparison of different distillation methods

| | Logits | Logits + Feat. | Feat. only |
|---|---|---|---|
| Accuracy | 72.1 | 73.1 | 77.2 |
| Marco-F1 | 26.4 | 26.9 | 34.0 |

The Meta-DMoE method 500 provides a framework for adaptation towards domain shift using unlabeled examples at test-time. The adaptation is formulated as a knowledge distillation process and a meta-learning algorithm is used to guide the student prediction network to fast adapt to unseen target domains via transferring the aggregated knowledge from multiple sources domain-specific models. Testing results has shown that the Meta-DMoE method 500 exhibits improved performance on four challenging benchmarks, and is competitive under two constrained real-world settings with a limited computational budget and domain data privacy regulation.

The Meta-DMoE method 500 may improve the capacity to capture complex knowledge from multi-source domains by increasing the number of experts. To compute the aggregated knowledge from domain-specific experts, every expert model may need to have one feed-forward pass. As a result, the total computational cost of adaptation scales linearly with the number of experts. Furthermore, to add or remove any domain-specific expert, both the aggregator and the student network may need to be re-trained from scratch.

With above description, those skilled in the art will appreciate that the Meta-DMoE method 500 in some embodiments uses the test-time adaptation as the process of knowledge distillation from multiple source domains. The Meta-DMoE method 500 incorporates the concept of MoE which is a natural fit for the multi-source domain settings. The MoE models are treated as the teacher models and separately trained on the corresponding domain to maximize their domain speciality. Given a new target domain, a few unlabeled data are collected therefrom to query the features from the MoE expert models. A transformer-based knowledge aggregator is used to examine the interconnection among queried knowledge and aggregate the correlated information toward the target domain. The output is then treated as a supervision signal to update a student prediction network (that is, a student model) to adapt to the target domain. The adapted student model is then used for subsequent inference. In some embodiments, bi-level optimization is employed as meta-learning to train the aggregator at the meta-level to improve generalization. The student prediction network is also meta-trained to achieve fast adaptation via a few samples. In some embodiments, the test-time OOD scenarios are simulated during training to align the training objective with the evaluation protocol.

The Meta-DMoE method 500 provides various advantages over ARM such as:
The Meta-DMoE method 500 provides a larger model capability to improve the generalization power;
Although the computational cost is relatively higher than ARM, only the adapted student network is kept for inference, and the MoE models are discarded after adaptation. Therefore, the Meta-DMoE method 500 is more flexible in designing the architectures for the teacher or student models (for example, providing compact models for the power-constrained environment);
The Meta-DMoE method 500 does not need to access the raw private data of source domains and only needs their trained models. Therefore, the Meta-DMoE method 500 may take advantage of private domains in a real-world setting where their raw private data is inaccessible.

In various embodiments, the Meta-DMoE method 500 employs MoE to allow each expert model to thoroughly explore each source domain. The Meta-DMoE method 500 aggregates the positive knowledge retrieved from MoE and uses the adaptation process for knowledge distillation. The alignment between training and evaluation objectives via meta-learning improves the adaptation and the test-time generalization. Thus, the Meta-DMoE method 500 provides an unsupervised test-time adaptation framework suitable for multiple sources domain settings, and is more flexible in real-world settings where computational power and data privacy are the concerns. Extensive testing and experiments show that the Meta-DMoE method 500 is superior over many prior-art methods. The testing and experiments also validate the effectiveness of each component of the Meta-DMoE method 500.

### Distilled Mixture-of-Teachers Method for Privacy-Enforced Efficient Domain Adaption

In some embodiments, the AI system 100 comprises a central server (such as a cloud vendor; acting as the training device 146) and a set of nodes where each node corresponds to an execution device 150 (also denoted a “client”). Each client or node has some training data. In these embodiments, each client is considered as a domain, and there exists domain shift between two different clients. Moreover, different local clients have two different levels of privacy concerns. Some clients (denoted “public clients”) are willing to share their training data with the central server while other clients (denoted “local clients”) are only willing to share a small public subset of their data with the central server.

In these embodiments, a Distilled Mixture-of-Teachers (DMOT) method is used to learn a model by leveraging both public and local clients. Given a new client (that is, a new domain), the AI system 100 has access to some unlabeled public data from the new client, and may quickly generate a model for the new client without violating the privacy restrictions of existing clients. In some embodiments, the generated model for the new client is a compact model.

As one of the use cases, the DMOT method may be used for solving the challenges of deploying computer-vision models in many real-world scenarios. In recent years, deep neural networks have achieved remarkable successes for many computer-vision tasks (such as image recognition). The two key factors of this success include the improvement of computing hardware and the availability of large-scale datasets. However, many real-world applications often have restrictions on computation and data availability.

For example, in a real-world application, an image-recognition model is deployed to a medical apparatus in a hospital, wherein three challenges, domain shift, privacy, and model size, need to be addressed. First, since each hospital has slightly different data collection setup. The data distribution of different hospitals can be drastically different. Such misalignment is known as distribution shift.

Second, due to the privacy regulation, only the non-private data from some hospitals are contributed to the public training set. The locally-stored private data cannot be sampled across hospitals to train a generic model following the standard learning protocol. As a result, the standard machine-learning approach cannot take advantage of the abundant private data (similar to the situation shown in FIG. 10). Third, the final model is often deployed to low-power edge devices which usually apply restrictions on memory and computational requirements for the deployed model. Therefore, the final model has to be compact.

In these embodiments, the DMOT method focuses on the problem of privacy-aware unsupervised domain adaptation. Such a problem setting simultaneously takes into account the domain shift, data privacy, and model size challenges in many real-world scenarios. The DMOT method generally involves three stages.

During the first stage, each local node or client trains an individual local model using the available data thereof. The local models are used as “teacher models” in subsequent stages, and there may be a plurality of teacher models depending on the number of clients. In the second stage, the central server learns to combine the teacher models by learning a “teacher selector”. In the third stage, given some unlabeled input data (such as unlabeled input images) from a target node, the teacher selector outputs the score or relative weight of each teacher-model output. The weighted ensemble of teacher-model outputs is then then used as a soft label to distill to a compact model. The compact model is then deployed to the target node.

Thus, the DMOT method may be used for the scenarios where there exists private data that cannot be shared. The DMOT method may also be used for the deployment scenarios where large domain shift and limitation on resources need to be considered.

As those skilled in the art will appreciate, two realistic limitations, that is, privacy and efficiency, are often imposed to domain adaptation. Thus in these embodiments, a realistic deployment problem, that is, privacy-enforced efficient domain adaption (PE-DA) is considered.

As described above, the data within a node belongs to the domain of that node. Each node comprises private data D_{priv.} and public data D_{pub.}. At test-time deployment, given a target node N^{T}={D_{priv.}^{T}, D_{pub.}^{T}}, D_{pub.}^{T} may be sent to other nodes or a global server to obtain a domain-adapted model, and the model is then deployed and performs predictions on D_{priv.}^{T}. In these embodiments, D_{pub.} is unlabeled to match many real-world applications, and therefore, the adaptation process may be in an unsupervised manner.

In complex real life scenarios, a novel target node is likely to have data distribution that does not align with the training nodes. Thus, the DMOT method explicitly separates the distributed training nodes into two non-overlapping set of nodes: N_{priv.}={D_{priv.}ⁱ}ᵢ₌₁^{M} and N_{pub.}={D_{pub.}^{j}}ⱼ₌₁^{Z}.

N_{priv.} contains M nodes (denoted “private nodes” hereinafter) with only private data that cannot be accessed by others. Moreover, the data of N_{priv.} can only be accessed locally during training, and cannot be seen at test-time.

For ease of description, N_{pub.} contains Z nodes (denoted “public nodes” hereinafter) with only public data that has fewer restrictions and can be transferred among nodes. Since only the public data of NT can be shared during testing, such splitting uses N_{pub.} to simulate N^{T} at training to learn the interaction with N_{priv.}. The reason to set N_{pub.} to have only public data is for the ease of comparison between the methods disclosed herein and some prior-art methods because the prior-art methods need to mix all {D_{pub.}}ⱼ₌₁^{Z} and store them in a server to draw a mini-batch for every training iterations, and such operation is not allowed for private data. However, a pseudo private data may be simulated by a held-out portion of {D_{pub.}}ⱼ₌₁^{Z} . In addition, the data in each node is denoted using symbol “x” and their corresponding label is denoted using symbol “y”. All nodes share the same label space [symbol] .

In various embodiments, the goal of PE-DA is to train a recognition model on nodes N_{priv.} and N_{pub.} under the above-described privacy-regulation, and more specifically, to achieve at least some of:
alleviating or solving the domain shift issue;
meeting privacy requirements (without sharing the private data {D_{priv.}ⁱ}ᵢ₌₁^{M} across various nodes);
lowered labeling cost (for example, unsupervised);
reduced model size (for example, being lightweight or compact); and
efficient adaptation (that is, improved scalability, for example, being scalable to increasing of user devices 150 that are willing to contribute to the database).

FIG. 18 is a flowchart showing the steps of a DMOT procedure 600 executed by one or more training devices 146 and/or one or more execution devices 150 for training and deploying an AI model to a target node, according to some embodiments of this disclosure.

In these embodiments, there are a plurality of (sometimes a large number of) user devices 160 contributing to the training data, wherein each user device is referred as a training node, and each training node has private and public data. Moreover, each training node comprises a private or domain-specific model that is trained only on their private data. As will be described in more detail below, the private models are used for deploying an AI model in a target node.

As shown in FIG. 18, when deploying the AI model to the target node, the target node collects some unlabeled data or target samples (step 602), and send them to all training nodes for applying to the private models thereof to obtain a set of classification scores (step 604). At step 606, an aggregator weights the scores to obtain a soft label (such as a probability or likelihood that may have a value between zero (0) and (1), in contrary to a “hard label” which takes the value of either zero (0) or one (1)) (step 608). The soft label is then used to distill a compact model using a suitable knowledge distillation method to obtain a compact AI model containing knowledge from all nodes (step 610). The obtained AI model is then deployed in the target node for subsequent inference.

There are several concerns with the above setting regarding how to train the aggregator and compact model in advance, such as (1) the randomly initialized student model is not capable to fully explore few-shot data and overfitting may occur; and (2) the compact model requires larger number of gradient steps in fine tuning for a relatively better accuracy, and therefore, the test-time adaptation is inefficient.

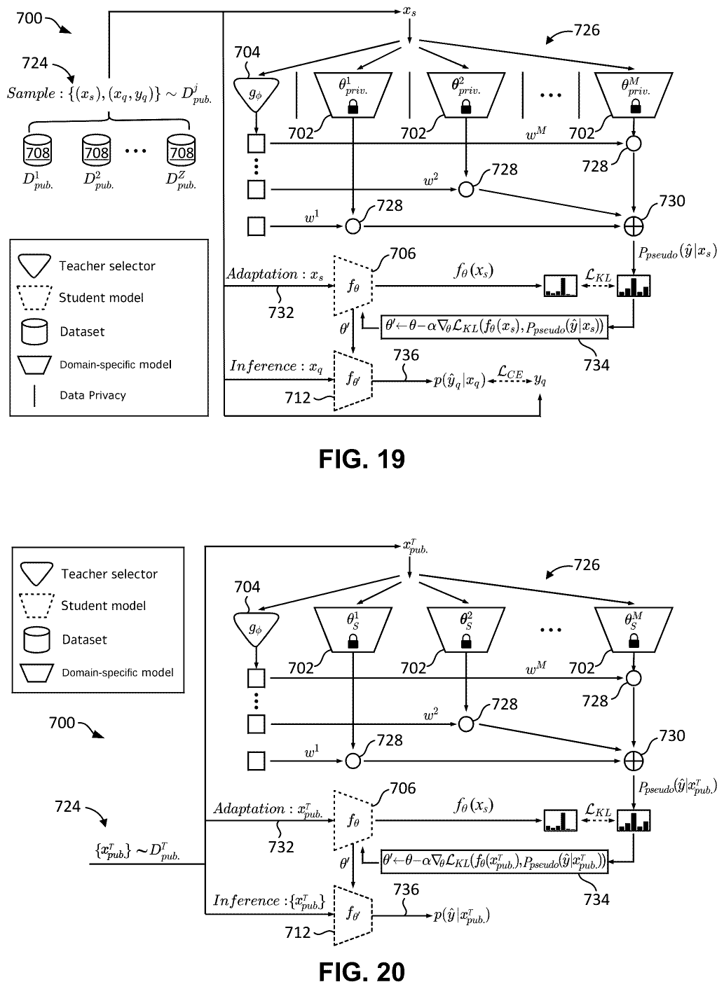

FIG. 19 is a flowchart showing the steps of a DMOT procedure 700 executed by one or more training devices 146 and/or one or more execution devices 150 for training and deploying an AI model to a target node, according to some embodiments of this disclosure.

The DMOT procedure 700 provides a framework for learning an adaptive compact model to tackle the PE-DA problem. Furthermore and as will be described in more detail below, the performance of the DMOT procedure 500 may be enhanced by using a meta-learning method to simulate the test-time adaptation and align the training and evaluation protocols.

In these embodiments, the DMOT procedure 700 trains a lightweight classification model fθ: [symbol] ¦ [symbol] ^{C} that is capable to adapt to target nodes N^{T} with C class categories. Since only the unlabeled D_{pub.}^{T} set is available, the DMOT procedure 700 follows the knowledge distillation paradigm to guide the adaptation and knowledge transfer using soft pseudo-labels produced at nodes N_{priv.}. The detail of the knowledge distillation paradigm may be found in academic paper entitled “Distilling the knowledge in a neural network” to Hinton, et al., published in arXiv preprint arXiv: 1503.02531 2(7) (2015), the content of which is incorporated herein by reference in its entirety.

Specifically, the DMOT procedure 700 comprises three important modules, namely M domain-specific teacher models {θ_{priv.}ⁱ}ᵢ₌₁^{M} (collectively identified as 702) of the M private nodes N_{priv.}, the teacher selector 704 (also denoted using symbol “g_{ø}”), and the lightweight adaptive student network 706 (that is, the student model; also denoted using symbol “f_{θ}”). Since the data in private nodes N_{priv.} is inaccessible during testing, the DMOT procedure 700 models the knowledge in N_{priv.} as the mixture of domain-specific teacher models 702 by training separate models 702 for each private node.

Let D_{priv.}ⁱ and θ_{priv.}ⁱ be the private data and domain-specific teacher model f: [symbol] → [symbol] ^{K} for the i-th node in N_{priv.}. Each θ_{priv.}ⁱ is trained using D_{priv.} with the CE loss. After training, we obtained a set of separate domain-specific models {θ_{priv.}ⁱ}ᵢ₌₁^{M}. The models are then “frozen” (that is, no longer updated) and stored locally in each node N_{priv.}. {D_{priv.}ⁱ}ᵢ₌₁^{M} are discarded according to PE-DA.

The Z public nodes N_{pub.}¹, N_{pub.}², . . . , N_{pub.}^{Z}. comprise public datasets D_{pub.}¹, D_{pub.}², . . . , D_{pub.}^{Z} (collectively identified as 708), respectively, that may be shared and gathered. The public datasets 708 are used to train the teacher selector g_{ø}(where g: [symbol] → [symbol] ^{M} and ϕ is the parameters of the teacher selector g) to produce a normalized weight vector {w¹, w², . . . , w^{M}}=g_{ϕ}(x) for weighting the teacher model outputs {f (x; θ_{priv.}^{j})}ᵢ₌₁^{M} under the constraints Σᵢ₌₁^{M} wⁱ1 and wⁱ≥0. The weight vector represents the knowledge transferability from each teacher domain and is used to determine the combination of teachers depending on the relationship between input and teacher domains.

More specifically, to learn the teacher selector g_{ø}, in each iteration or episode, a node j is selected (for example, randomly selected) from the Z nodes, and a batch of labeled training pairs {x, y} are sampled from the public data D_{pub.}^{j} of node j, which are then split into a support set xₛ and a query set (x_{q}, y_{q}) as in conventional meta-learning (step 724), where x represents the input data sample (such as an input image) and y represents the corresponding label. The support set xₛ is unlabeled to mimic the inference scenario and prevent manual labeling from the users.

At step 726, the support set xₛ is sent to the teacher models {0priv. }=1. Then, the vector of domain-specific teacher outputs is:

o(xₛ)={o¹, o², . . . , o^{M}}={f(xₛ; ∛_{priv.}¹), f(xₛ; θ_{priv.}²), . . . , f(xₛ; θ_{priv.}^{M})} (4)

The teacher model outputs o(xₛ) are weighted by the normalized weight vector g_{ϕ}(x)={w¹, w², . . . , w^{M}} (step 728), and then combined to obtain soft pseudo-label P_{pseudo}(ŷ|xₛ) (step 730). The predictive distribution of the support set xₛ and its soft pseudo-label may be modeled as the knowledge transferred from a mixture of teacher models. Thus, the soft pseudo-label of the support set xₛ may be calculated as:

$${P}_{pseudo} ( \hat{y} \vert {x}_{s} ) = {g}_{ϕ} ( {x}_{s} ) \cdot o ( {x}_{s} ) = {\sum }_{i = 1}^{M} {w}^{i} \cdot f ( {x}_{s} ; {θ}_{priv .}^{i} ) \qquad ( 5 )$$

At test-time, the support set xₛ is used for updating or adapting the student network f_{θ} (step 732) using the gradient decent method and KL divergence loss (a loss calculated based on the KL divergence or distance which is a statistical distance measuring how two probability distributions are different from each other) to obtain the updated student network 712 or f_{θ′}.

At step 732, a meta-distillation method is used to distill the domain knowledge and adapt the compact model f_{θ} to the target node N^{T} via simulating the test-time adaptation process using {D_{pub.}^{j}}ᵢ₌₁^{Z}, wherein a bi-level optimization training may be used to train a domain-agnostic initialization for the student model and enable the selector to learn beyond any specific knowledge.

Specifically, in each episode, xₛ (which is sampled from D_{pub.}^{j}) is used to generate the soft labels P_{pseudo}(ŷ|xₛ) using Equation (5), which represent the domain knowledge transferred from teacher models 702. The student model f_{θ} is then updated (step 734; also see Lines 11 to 12 of Algorithm 2 below) using a gradient decent method to minimize the KL divergence as

θ′←θ−α∇_{θ}Σ [symbol] _{KL}(f_{θ}(xₛ), P_{pseudo}( [symbol] xₛ)) (6)

for K steps to obtain the updated student model 712 or f_{θ′}, where α is the learning rate (see Lines L13 to 16 of Algorithm 2 below).

Herein, g and f are differentiable with respect to ϕ and θ. Thus, after adaptation, the updated student model f_{θ′} is evaluated on the labeled query set (x_{q}, y_{q}) for computing a CE loss [symbol] _{CE} between [symbol] _{q} and for f_{θ′}( [symbol] _{q}) (that is, [symbol] _{CE}(f_{θ′}( [symbol] _{q}), [symbol] _{q})) (step 736), and ϕ and θ are updated using a gradient decent method to minimize the loss [symbol] _{CE} (see Line 18 of Algorithm 2 below).

The updating process can be translated as: when the model is updated using unlabeled target data, it should be adapted to the target node and suitable for subsequent recognition tasks. The bi-level optimization ensures that the updated f_{θ′} using unlabeled target data is beneficial in adapting to the target node or target domain.

Now, f_{θ′} may be deployed for inference on future unlabeled examples collected in the target node (for example, Dpriv.).

Algorithm 2 below shows an exemplary implementation of the DMOT procedure 700.

Algorithm 2 Training for Meta-DMoT

```
Require: {D_{priv.}ⁱ}ᵢ₌₁^{M}: the dataset of private nodes. {D_{pub.}^{j}}ⱼ₌₁^{Z}: the dataset of public
  nodes.
Require: learning rates: α, β; number of inner updates: K
  1: // Pretrain domain-specific teacher models
  2: for i=1,...,M do
  3: Train the domain-specific model θ_{priv.}ⁱ using D_{priv.}ⁱ locally.
  4: Freeze θ_{priv.}ⁱ and store locally.
  5: end for
  6: // Meta-Train the teacher selector and the student model
  7: Initialize: θ, ϕ
  8: while not converged do
  9: Sample one domain dataset D_{pub.}^{j} uniformly from {D_{pub.}^{j}}ⱼ₌₁^{Z}
10: Sample the support set (xₛ) and the query set (x_{q}, [symbol]  _{q}) from D_{pub.}^{j}
11: Compute domain-specific outputs {f(xₛ; θ_{priv.}ⁱ)}ᵢ₌₁^{M} using Equation (4)
12: Compute weight coefficients {wᵢ}ᵢ₌₁^{M} via the teacher selector g_{ϕ} and obtain the
  soft pseudo-label P_{pseudo}( [symbol]  |xₛ) using Equation (5)
13: for t=1,...,K do
14: Inner update the student network θ given the soft pseudo-label
  P_{pseudo}( [symbol]  |xₛ):
15: θ′ ← θ − α∇_{θ} [symbol] _{K L}( [symbol]  ₛ, P_{pseudo}( [symbol]  |xₛ))
16: end for
17: Compute the meta loss on x_{q} and perform the meta update:
18: Update (ϕ, θ) ← (ϕ, θ) − β∇_{(ϕ, θ)} [symbol] _{C E}(f_{θ′} (x_{q}), [symbol] _{q})
19: end while
```

As shown, Algorithm 2 first pre-trains multiple domain-specific teacher models {θ_{priv.}ⁱ}ᵢ₌₁^{M} using local private data separately. Then, to follow the episodic-training, Algorithm 2 samples an unlabeled support set S=(xₛ) and a labeled query set Q=(x_{q}, y_{q}) from a pubic node. To simulate the test-time adaptation process, Algorithm 2 queries the soft pseudo-label P_{pseudo}(ŷ|xₛ) from the mixture of teacher models as the distilled knowledge to guide the adaptation of the student model f_{θ}. The adapted model f_{θ′} is evaluated on Q to jointly meta-update the parameters of the teacher selector g_{ϕ} and the student model initialization θ.

Those skilled in the art will appreciate that the DMOT procedure 700 and Algorithm 2 use a first optimization for minimizing the KL divergence (in the inner loop of Lines 13 to 16 of Algorithm 2) and a second optimization for minimizing the CE loss (Line 18 of Algorithm 2). Such a bi-level optimization achieves learning to adapt.

After the meta-training procedure, a testing set may be used as the target domains N^{T}. For each node in N_{T}, a few unlabeled data samples (such as images) are sampled to perform adaptation (Lines 12 to 16 of Algorithm 2) to obtain θ′. f_{θ′} is then used to predict and evaluate the images in N_{T}.

In some embodiments, the adaptation step 732 uses a suitable knowledge distillation method to distill the domain knowledge and adapt the compact model f_{θ} to the target node N^{T} with only access to its public unlabeled samples. FIG. 20 shows the flowchart of the DMOT procedure 700 according to some embodiments of this disclosure. The DMOT procedure 700 in these embodiments is similar to that shown in FIG. 19 except that, in these embodiments, step 724 obtains the sample data by sampling from the public data D_{pub.} of the target node N_{T}. Specifically, the public unlabeled dataset of the target node D_{pub.}={x_{pub.}^{T}} is sent to the teacher models 702 to query their domain-specific outputs and generate the soft labels P_{pseudo}(ŷ|x_{pub.}^{T}) using Equation (5) (replacing xₛ with x_{pub.}^{T}) which represent the domain knowledge transferred from teacher models 702. The student model fe may then be fine-tuned (step 734) using gradient decent by minimizing the KL divergence as

θ′∴θ−α∇_{θ}Σ [symbol] _{KL})f_{θ})x^{T}), P_{pseudo}( [symbol] |x_{pub}^{T})) (7)

for K steps to obtain the updated student model 712 or f_{θ′}, where α is the learning rate.

The DMOT method in these embodiments may be sub-optimal in both performance and efficiency compared to the DMOT method shown in FIG. 19 due to several limitations. First, the randomly initialized student model is not capable to fully explore few-shot data and over-fit may occur. Second, it requires larger number of gradient steps in fine-tuning for a relatively better accuracy as in Table 5 below (K=25). It causes inefficient adaptation and the computational cost of adaptation is linearly scaled with K. Third, the learning objective may not align with the evaluation protocol, which is non-optimal. At test-time, the adaptation takes places on D_{pub.}^{T} but evaluation is performed on D_{priv.}^{T}

But, the training objective of the selector g aims to minimize the loss towards the data in N_{pub.}. It may be biased and limit the generalization to new target domains. However, it is a selective mechanism and should not be biased to any of the knowledge. In addition, the student model is not trained along with the selector, which is defective compared to end-to-end training solutions.

Testing results of the DMOT method 700 are now described.

The testing of the DMOT method 700 focuses on the real-world domain shift scenarios, and the DMOT method 700 is evaluated on WILDS benchmark which reflects a diverse range of distribution shifts (for example, across time, location and devices) that naturally emerges in real life. Experiments are mainly performed on two subsets of WILDS for image recognition task, namely iWildCam and FMoW.

As those skilled in the art understand, iWildCam contains 203,029 wild animal images with 182 animal species (C=182) taken by 323 camera traps that are deployed by the ecologists. Each camera traps is treated as one domain. The testing uses the official training, OOD validation and OOD test splits with 243, 32, 48 camera traps data to train and evaluate the DMOT method 700. The images are resized to 448×448 for training.

FMoW consists of satellite imageries to monitor global economic challenges. WILDS formulates it as hybrid domain generalization and subpopulation shift problem. The testing adopts the domain generalization portion where images taken within the same year are considered as one domain. There are total of 118,886 images with 224×224 resolution of 62 location categories (C=62) for 16 domains (years). The official training, OOD validation and OOD test splits contain 11, 3, 2 domains, respectively. Note, for both datasets, the domains for training, validation, and testing are non-overlapping. However, they share the same types of image categories (label space)y).

The testing follows the setting as in WILDS to use ResNet50 for iWildCam and DenseNet121 for FMoW for both domain-specific models {θ_{priv.}ⁱ}ᵢ₌₁^{M} and selector g_{ϕ}. As for the compact student model f_{θ}, we utilize lightweight MobileNet V2 with width multiplier equals to 0.25 to further shrink the model size. Note, ResNet50 and DenseNet121 are 90 MB and 27.1 MB, while MobileNet V2 (0.25) is only 1.1 MB when stored on disk, which is very limiting.

The testing uses the evaluation scripts described in the academic paper entitled “Wilds: A benchmark of in-the-wild distribution shifts” to Koh, et al., published in International Conference on Machine Learning. pp. 5637-5664. PMLR (2021), the content of which is incorporated herein by reference in its entirety, to calculate average accuracy for both datasets. The testing also reports Macro-F1 score for iWildCam and worst-case accuracy for FMoW.

In the testing, 100 domains are randomly selected from iWildCam training split for N_{priv.} to train {θ_{priv.}ⁱ}ᵢ₌₁^{M} and the rest for N_{pub.} to train selector g_{ϕ} and student f_{θ}. As for FMoW, the testing randomly selects 6 domains of data for N_{priv.} and the rest for N_{pub.} since iWildCam and FMoW are highly imbalanced, and using every single domain to train a classifier is unstable and sometimes it cannot converge. In the testing, the domains are merged into 10 and 3 super-domains, respectively.

In the testing, each of the domain-specific models {{θ_{priv.}ⁱ}ᵢ₌₁^{M} is separately trained. Models pre-trained on ImageNet [7] are used as initialization. All models are trained using Adam optimizer with learning rate of 1e⁻⁴ and a decay of 0.96 per epoch. The batch size is set to 32, 64 and training epoch is set to 12 and 50 for iWildCam and FMoW, respectively.

For iWildCam, (α, β) is set as (1e⁻⁴, 3e⁻⁴) for larger models and (3e⁻⁵, 1e⁻⁴) for compact models. As for FMoW, (1e⁻⁴, 3e⁻⁴) and (3e-⁻⁵, 3e⁻⁵) are set for (α, β) for large and compact models, respectively. Training ends after 15 and 30 epochs for those two datasets. The testing sets K=1 for fast adaptation.

For all training procedures, the hyper parameters are tuned using the validation split and adopt model with lowest validation loss for testing.

In the testing, the DMOT method 700 is compared with the methods appearing on the leaderboard of WILDS, including Fish, ERM, IRM, CORAL, ARM-CML, ARM-BN, and ARM-LL. The testing results described below are with large/compact models and with or without utilizing private data for training. When using all data, the private and public data are mixed as one dataset to train other methods. When using only public data, the private data is discarded for other methods. As for the DMOT method 700, the domain-specific models are trained using the private data and then the private data for both cases is discarded. The meta-train stage utilizes all the data or only the public data.

Table 9 shows the comparison of the DMOT method 700 with Fish, ERM, IRM, CORAL, ARM-CML, ARM-BN, and ARM-LL.

TABLE 9
Comparison of the DMoT method 700 with some prior-art methods on real-world domain
shift dataset iWildCam and FMoW.

| | Datasets | | | | | |
|---|---|---|---|---|---|---|
| | iWildCam (Average acc./Micro F1) | | | FMoW (Average acc./Worst-case acc.) | | |
| | Accessible data | | | | | |
| | All data | | Public data only | All data | | Public data only |
| | Architecture | | | | | |
| | ResNet50 | MobileNet V2 | MobileNet V2 | DenseNet121 | MobileNet V2 | MobileNet V2 |
| Fish | 64.7/22.0 | 58.8/11.3 | 50.7/4.2 | 57.8/34.6 | 40.1/25.3 | 26.0/20.4 |
| ERM | 71.6/31.0 | 59.7/11.5 | 50.7/3.3 | 54.0/33.7 | 40.0/22.9 | 35.4/22.5 |
| IRM | 59.8/15.1 | 50.1/18.4 | 49.7/4.6 | 50.8/30.0 | 39.0/26.6 | 33.7/22.4 |
| CORAL | 73.3/32.8 | 65.4/18.5 | 51.7/4.6 | 50.5/31.7 | 30.1/23.4 | 24.9/17.5 |
| ARM-CML | 59.7/9.90 | 88.0/2.50 | 35.7/1.6 | 45.3/27.4 | 30.1/20.8 | 24.1/16.8 |
| ARM-BN | 70.3/23.7 | 40.9/12.2 | 34.2/1.5 | 42.0/24.6 | 28.3/16.3 | 22.2/14.2 |
| ARM-LL | 70.9/26.5 | 67.5/12.3 | 46.8/0.2 | 41.9/22.2 | 28.0/17.5 | 22.6/13.7 |
| DMoT | 72.8/25.9 | 58.5/10.0 | 55.3/7.4 | 53.0/28.6 | 89.2/28.8 | 38.4/23.8 |

As can be seen, reducing the model size greatly limits the learning capacity of the methods. Therefore, the performance of all tested methods dramatically decrease (column 1-2 and 4-5). Limiting the training by only accessing the public data further degrades the performance. The tested prior-art methods rely only on the publicly available data for training, whereas private knowledge is never used. In contrast, the DMOT method 700 naturally utilizes the private knowledge that is encoded in the domain specific-models, and thus is more robust to handle the privacy-enforced situation in real-world. In the DMOT method 700, the adaptation process transfers beneficial information from the edge models according to the data in the new domain without accessing the private data. Therefore, the student model better addresses the distribution shift problem with selective diverse prior knowledge.

Thus, the DMOT method 700 achieves superior results with compact model. Compared to the tested prior-art methods, the DMOT method 700 experiences less performance degradation when the private data is inaccessible (column 2 vs. 3 and 5 vs. 6.).

ARM also applies meta-learning approach to learn how to adapt to new domains for each unlabeled data. However, their method is greatly bounded by the training data and does not directly incorporate with compact models. As a result, drastically reducing the model size has huge impact (columns 1-2 and 4-5). In contrast, the meta-distillation of the DMOT method 700 is more fitted to PE-DA setting and meta-trains a selector that properly guides the knowledge transfer from large models to a compact one. Thus, for the real-world environments (compact model and inaccessible private data), the DMOT method 700 outperforms ARM-CML, ARM-BN, and ARM-LL by 19.6%, 21.1%, 8.5% for iWildCam and 14.3%, 16.2%, 15.8% for FMoW in terms of average accuracy (columns 3 and 6).

Ablation studies are also conducted on iWildCam to verify and analyze various components of the DMOT method 700. The models are picked according to validation loss, and their performance on the test split is reported.

Three training methods are investigated for both selector and student models, including random initialization, pre-train, and meta-train. Pre-training follows regular supervised training method using {D_{pub.}^{j}}ⱼ₌₁^{Z}. In the testing, ResNet18 is used for private models and MobileNetV2 is used for both selector and student. The testing uses 32 images and 1 gradient update for adaptation for each domain node.

Table 10 shows the testing results of different training method combinations.

TABLE 10
Ablation studies on training methods and model architecture

| Network structure | | | Training scheme | | Evaluation metric | |
|---|---|---|---|---|---|---|
| Private models | Selector | Student | Selector | Student | Accuracy | Macro-F1 |
| ResNet18 | MobileNet V2 | MobileNet V2 | Pre-train | Random | 0.50 | 0.03 |
| | | | Meta-train | Random | 8.00 | 0.07 |
| | | | Pre-train | Pre-train | 36.4 | 2.30 |
| | | | Meta-train | Pre-train | 51.5 | 2.98 |
| | | | Meta-train | Meta-train | 51.7 | 4.05 |
| ResNet18 | MobileNet V2 | ResNet50 | Meta-train | Meta-train | 68.2 | 18.5 |
| ResNet18 | ResNet50 | ResNet50 | | | 72.0 | 25.3 |
| ResNet50 | ResNet50 | MobileNet V2 | | | 58.5 | 10.0 |
| ResNet50 | ResNet50 | ResNet50 | | | 72.4 | 25.5 |

Randomly initialized student model struggles to learn with only few-shot data, and thus the performance thereof is low. A pre-trained student model may take the advantage of learned knowledge from publicly available data, and thus the performance thereof is boosted compared to the random one (row 1 vs. row 3). As for the selector, the pre-trained version shows weak adaptation guidance as it is not fully learned to do so. However, during the meta-training of the DMOT method 700, the meta-objective enforces the selector to choose important knowledge from the private models to support the student model adaptation. Therefore, the meta-learned selector is much more optimal compared to other training methods (row 1 vs. row 2, and row 3 vs. row 4). Furthermore, the meta-distillation training process of the DMOT method 700 simulates the adaptation in testing scenarios, which aligns the training objective and evaluation protocol. Hence, for both meta-trained selector and student models, it gains additional improvement (row 4 vs. row 5).

Thus, the meta-training method of the DMOT method 700 exhibits higher performance compared to other training methods as the meta-training method enforces the selector to guide the student model adaptation. Larger architectures are also beneficial for all model, indicating the importance of improving the performance for compact models for harsh environments.

Experiments are also conducted to illustrate the impact of model size. As reported in row 6 of Table 10, replacing only the student model with a larger architecture brings obvious improvement. In other words, for harsh power-constrained environment, a higher model performance cannot be guaranteed. Thus, it is needed to consider the distribution shift under such condition. Enlarging selector model brings additional improvement. Comparison of rows 7 and 9 indicates that it is beneficial to utilize larger architecture for the domain-specific models. As those model may run on more powerful local servers, developing complex algorithms may be a choice to better encode the useful knowledge of the private data.

The distribution of a new domain may be estimated using sufficient data points sampled from that domain. Thus, the number of unlabeled data from each domain for adaptation plays an important role, which is investigated in the testing with both large and compact architectures. As shown in Table 11, for both cases, performing adaptation on more images yields better performance. For both architectures, the DMOT method 700 may perform relatively well even when few images are available for adaptation (such as two (2) images). It reduces the burden of both adaptation cost and data collection of the nodes with improved protection on their privacy. Depending on the trade-off between computational cost and accuracy, a node can decide more or fewer images for adaptation.

TABLE 11
Impact of the number of unlabeled data for adaptation

| # of | Student (ResNet50) | | Student (MobileNet V2) | |
|---|---|---|---|---|
| images | Accuracy | Macro-F1 | Accuracy | Macro-F1 |
| 2 | 68.67 | 20.45 | 52.40 | 6.10 |
| 4 | 68.79 | 20.30 | 52.88 | 6.53 |
| 8 | 69.87 | 20.78 | 53.87 | 6.52 |
| 16 | 70.23 | 21.02 | 54.79 | 7.23 |
| 32 | 72.40 | 25.50 | 55.31 | 7.43 |

The DMOT method 700 naturally fits the above-described problem setting by separately encoding each private data and transferring the encoded knowledge to the target domain. Therefore, the source of the knowledge to be transferred is important. Abundant and diverse private data are in favor of improving the adaptation quality and further alleviating the distribution shift problem. Table 12 reports the results of different number of teachers (that is, the domain-specific models), wherein random selection is used for less than 10 teachers. As shown, more teacher is beneficial as there is higher chance to find similar domains or data knowledge to contribute to the adaptation process, and thus diverse private data is in favor of improving knowledge transfer and adaptation.

TABLE 12
Impact of the number of available teachers

| # of teachers | Accuracy | Micro-F1 |
|---|---|---|
| 2 | 44.0 | 6.0 |
| 5 | 49.7 | 7.2 |
| 7 | 54.1 | 7.4 |
| 10 | 55.3 | 7.4 |

PE-DA requires efficient adaptation process for each node to be applicable for the real-world scenarios. In the testing, the efficiency using multiply-Accumulate operations (MACS) is analyzed and reported in Table 13. As can be seen, the randomly initialized student requires around 25 steps to achieve a relatively good accuracy. On the other hand. The meta-trained student model of the DMOT method 700 may boost the performance with only one (1) adaptation step. It reflects the effectiveness of the Meta-DMOT training method. With respect to the computation cost of the teacher modules (which is large portion of the total cost), as the teacher models are distributed, they may run in parallel to efficiently reduce the running time.

TABLE 13
Ablation studies

| | | Macro- | Teachers | Adaptation | Adaptation |
|---|---|---|---|---|---|
| Method | Accuracy | F1 | MACS | MACS | steps |
| Fine tune | 0.10 | 0.06 | 2.88 × 10¹² | 1.38 × 10¹¹ | 1 step |
| from | 20.3 | 1.50 | | 3.28 × 10¹² | 25 steps |
| random | 19.8 | 2.10 | | 6.38 x 10¹² | 50 steps |
| Meta- | 55.3 | 7.40 | | 1.38 × 10¹¹ | 1 step |
| learned | | | | | |

Thus, the DMOT method 700 disclosed herein provides private model distillation, and addresses domain shift in a realistic setting with source-free, multi-source adaptation. The DMOT method 700 disclosed herein also provides fast adaptation which only needs a few unlabeled data and steps to adapt the AI model to the target node.

In above embodiments, the DMOT method 700 only uses private data in training and deploying the target AI model. In some embodiments wherein public data is available, the DMOT method 700 may also use the public data in training and deploying the target AI model wherein the public data may be considered as if the data from additional one or more private source domains. Alternatively, the public data may be collected for meta-training stage as in Algorithm 1.

In some embodiments, the above-described procedures 500, 600, and 700 may be used for personalization. In these embodiments, each of a plurality of nodes has its own data, and the above-described procedures 500, 600, and 700 may be used to personalize an AI model for each node.

Although embodiments have been described above with reference to the accompanying drawings, those of skill in the art will appreciate that variations and modifications may be made without departing from the scope thereof as defined by the appended claims.

What is claimed is:

1. A method comprising:
obtaining a set of training samples from one or more domains;
using the set of training samples to query a plurality of artificial-intelligence (AI) models;
combining the outputs of the queried AI models; and
adapting a target AI model via knowledge distillation using the combined outputs.

2. The method of claim 1, wherein said combining the outputs of the queried AI models comprises:
using a transformer encoder for combining the outputs of the queried AI models.

3. The method of claim 1, wherein said obtaining the set of training samples from the one or more domains comprises:
obtaining the set of training samples from a plurality of domains, the set of training samples comprises a plurality of subsets of training samples obtained from the plurality of domains;
wherein said using the set of training samples to query the plurality of AI models comprises:
using each subset of training samples to query the plurality of AI models except an excluded AI model of the plurality of AI models; and
wherein the excluded AI models of the plurality of subset of training samples are different AI models.

4. The method of claim 1, wherein said combining the outputs of the queried AI models comprises:
weighting the outputs of the queried AI models, and
combining the weighted outputs of the queried AI models to obtain a soft pseudo-label; and
wherein said adapting the target AI model via the knowledge distillation using the combined outputs comprises:
adapting the target AI model via the knowledge distillation using the soft pseudo-label.

5. The method of claim 4, wherein said adapting the target AI model via the knowledge distillation using the combined outputs and the soft pseudo-label comprises:
querying the target AI model using the set of training samples; and
adapting the target AI model via the knowledge distillation based on Kullback-Leibler (KL) divergence of the output of the queried target AI model and the soft pseudo-label.

6. The method of claim 5, wherein said adapting the target AI model via the knowledge distillation based on the KL divergence of the output of the queried target AI model and the soft pseudo-label comprises:
minimizing the KL divergence using a gradient decent method.

7. The method of claim 1 further comprising:
evaluating a loss of the target AI model; and
updating a plurality of parameters based on the evaluated loss;
wherein the plurality of parameters comprises one or more first parameters of the target AI model and a parameter used in said combining the outputs of the queried AI models.

8. The method of claim 7, wherein said evaluating a loss of the target AI model comprises:
querying the target AI model using a set of query samples, and evaluating a cross-entropy (CE) loss between the outputs of the queried target AI model and a set of labels corresponding to the set of query samples; and
wherein said updating the plurality of parameters based on the evaluated loss comprises:
updating the plurality of parameters by minimizing the CE loss.

9. The method of claim 8, wherein said updating the plurality of parameters by minimizing the CE loss comprises:
updating the plurality of parameters by minimizing the CE loss using a gradient decent method.

10. An apparatus comprising:
at least one processor for performing actions comprising:
obtaining a set of training samples from one or more domains;
using the set of training samples to query a plurality of AI models;
combining the outputs of the queried AI models; and
adapting a target AI model via knowledge distillation using the combined outputs.

11. The apparatus of claim 10, wherein said combining the outputs of the queried AI models comprises:
using a transformer encoder for combining the outputs of the queried AI models.

12. The apparatus of claim 10, wherein said obtaining the set of training samples from the one or more domains comprises:
obtaining the set of training samples from a plurality of domains, the set of training samples comprises a plurality of subsets of training samples obtained from the plurality of domains;
wherein said using the set of training samples to query the plurality of AI models comprises:
using each subset of training samples to query the plurality of AI models except an excluded AI model of the plurality of AI models; and
wherein the excluded AI models of the plurality of subset of training samples are different AI models.

13. The apparatus of claim 10, wherein said combining the outputs of the queried AI models comprises:
weighting the outputs of the queried AI models, and
combining the weighted outputs of the queried AI models to obtain a soft pseudo-label; and
wherein said adapting the target AI model via the knowledge distillation using the combined outputs comprises:
adapting the target AI model via the knowledge distillation using the soft pseudo-label.

14. The apparatus of claim 13, wherein said adapting the target AI model via the knowledge distillation using the combined outputs and the soft pseudo-label comprises:
querying the target AI model using the set of training samples; and
adapting the target AI model via the knowledge distillation based on KL divergence of the output of the queried target AI model and the soft pseudo-label.

15. The apparatus of claim 10, wherein the at least one processor is configured for performing further actions comprising:
evaluating a loss of the target AI model; and
updating a plurality of parameters based on the evaluated loss;
wherein the plurality of parameters comprises one or more first parameters of the target AI model and a parameter used in said combining the outputs of the queried AI models.

16. The apparatus of claim 15, wherein said evaluating a loss of the target AI model comprises:
querying the target AI model using a set of query samples, and evaluating a CE loss between the outputs of the queried target AI model and a set of labels corresponding to the set of query samples; and
wherein said updating the plurality of parameters based on the evaluated loss comprises:
updating the plurality of parameters by minimizing the CE loss.

17. One or more non-transitory computer-readable storage devices comprising computer-executable instructions, wherein the instructions, when executed, cause a processing structure to perform actions comprising:
obtaining a set of training samples from one or more domains;
using the set of training samples to query a plurality of AI models;
combining the outputs of the queried AI models; and
adapting a target AI model via knowledge distillation using the combined outputs.

18. The one or more non-transitory computer-readable storage devices of claim 17, wherein said combining the outputs of the queried AI models comprises:
using a transformer encoder for combining the outputs of the queried AI models.

19. The one or more non-transitory computer-readable storage devices of claim 17, wherein said obtaining the set of training samples from the one or more domains comprises:
obtaining the set of training samples from a plurality of domains, the set of training samples comprises a plurality of subsets of training samples obtained from the plurality of domains;
wherein said using the set of training samples to query the plurality of AI models comprises:
using each subset of training samples to query the plurality of AI models except an excluded AI model of the plurality of AI models; and
wherein the excluded AI models of the plurality of subset of training samples are different AI models.

20. The one or more non-transitory computer-readable storage devices of claim 17, wherein said combining the outputs of the queried AI models comprises:
weighting the outputs of the queried AI models, and combining the weighted outputs of the queried AI models to obtain a soft pseudo-label; and
wherein said adapting the target AI model via the knowledge distillation using the combined outputs comprises:
adapting the target AI model via the knowledge distillation using the soft pseudo-label.

21. The one or more non-transitory computer-readable storage devices of claim 20, wherein said adapting the target AI model via the knowledge distillation using the combined outputs and the soft pseudo-label comprises:
querying the target AI model using the set of training samples; and
adapting the target AI model via the knowledge distillation based on KL divergence of the output of the queried target AI model and the soft pseudo-label.

22. The one or more non-transitory computer-readable storage devices of claim 17, wherein the instructions, when executed, cause the processing structure to perform further actions comprising:
evaluating a loss of the target AI model; and
updating a plurality of parameters based on the evaluated loss;
wherein the plurality of parameters comprises one or more first parameters of the target AI model and a parameter used in said combining the outputs of the queried AI models.

23. The one or more non-transitory computer-readable storage devices of claim 22, wherein said evaluating a loss of the target AI model comprises:
querying the target AI model using a set of query samples, and evaluating a CE loss between the outputs of the queried target AI model and a set of labels corresponding to the set of query samples; and
wherein said updating the plurality of parameters based on the evaluated loss comprises:
updating the plurality of parameters by minimizing the CE loss.
